(19) United States
(12) Patent Application Publication
(10) Pub. No.: US 2025/0293833 A1
(43) Pub. Date: Sep. 18, 2025

(54) METHODS, DEVICES, AND COMPUTER READABLE MEDIUM FOR COMMUNICATION

(71) Applicant: NEC Corporation, Tokyo (JP)

(72) Inventors: Yukai GAO, Beijing (CM); Peng GUAN, Beijing (CN); Gang WANG, Beijing (CM)

(73) Assignee: NEC Corporation, Tokyo (JP)

(21) Appl. No.: 18/860,178

(22) PCT Filed: Apr. 28, 2022
(86) PCT No.: PCT/CN2022/090079

§ 371 Date: Oct. 25, 2024

(51) Int. Cl. H04L 5/00; H04B 7/06

(52) U.S. Cl. CPC H04L 5/0051; H04B 7/06

(57) ABSTRACT

A terminal device receives a configuration for a codebook which includes: a first plurality of antenna port groups and a plurality of antenna ports in one antenna port group. The terminal device transmits a number of layers and a codebook indicator based on the codebook configuration which includes: an indicator of second vectors, and indicators for at least one of: a second plurality of antenna port groups, first amplitude coefficients, and first phase coefficients. First vectors are determined based on the plurality of second vectors and the first amplitude coefficients and/or the first phase coefficients. At least one of a length of a first vector, a number of first vectors and a size of the one or more indicators of the second vectors is based on a number of the second plurality of antenna port groups and/or the first amplitude coefficients.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For example, multi input multi output (MIMO) has been proposed. MIMO includes features that facilitate utilization of a large number of antenna elements at base station for both sub-6 GHZ and over-6 GHz frequency bands. In this situation, a plurality of antennas at a transmitter and/or receiver can be used to achieve array and diversity gain instead of capacity gain. In this case, a same symbol weighted by a complex-valued scale factor is sent from each transmit antenna so that the input covariance matrix has unit rank. This scheme is referred to as beamforming. When the receiver has multiple antennas, the single-layer beamforming cannot simultaneously maximize the signal power at every receive antenna, hence, precoding is used for multi-layer beamforming in order to maximize the throughput of a multi-antenna system. Precoding is a generalized beamforming scheme to support multi-layer transmission in a MIMO system. Using precoding, multiple streams are transmitted from the transmit antennas with independent and appropriate weighting per antenna such that the throughput is maximized at the receiver output.

### SUMMARY

In general, example embodiments of the present disclosure provide a solution for communication.

In a first aspect, there is provided a method for communication. The method comprises receiving, at a terminal device and from a network device, at least one configuration for codebook, wherein the at least one configuration for codebook comprises: a first plurality of antenna port groups and a plurality of antenna ports in one antenna port group; and transmitting, to the network device, a number of layers and at least one codebook indicator based on the at least one configuration for codebook, wherein the at least one codebook indicator comprises: one or more indicators of a plurality of second vectors, and at least one of: one or more indicators of a second plurality of antenna port groups, one or more indicators for a plurality of first amplitude coefficients, one or more indicators for a plurality of first phase coefficients, wherein a plurality of first vectors is determined based on the plurality of second vectors and at least one of the plurality of first amplitude coefficients and the plurality of first phase coefficients, wherein at least one of a length of a first vector, a number of the plurality of first vectors and a size of the one or more indicators of the plurality of second vectors is based on at least one of a number of the second plurality of antenna port groups and the plurality of first amplitude coefficients.

In a second aspect, there is provided a method for communication. The method comprises transmitting, at a network device, to a terminal device, at least one configuration for codebook, wherein the at least one configuration for codebook comprises: a first plurality of antenna port groups and a plurality of antenna ports in one antenna port group; and receiving, from the terminal device, a number of layers and at least one codebook indicator based on the at least one configuration for codebook, wherein the at least one codebook indicator comprises: one or more indicators of a plurality of second vectors, and at least one of: one or more indicators of a second plurality of antenna port groups, one or more indicators for a plurality of first amplitude coefficients, one or more indicators for a plurality of first phase coefficients, wherein a plurality of first vectors is determined based on the plurality of second vectors and at least one of the plurality of first amplitude coefficients and the plurality of first phase coefficients, wherein at least one of a length of a first vector, a number of the plurality of first vectors and a size of the one or more indicators of the plurality of second vectors is based on at least one of a number of the second plurality of antenna port groups and the plurality of first amplitude coefficients.

In a third aspect, there is provided a terminal device. The terminal device comprises a processing unit; and a memory coupled to the processing unit and storing instructions thereon, the instructions, when executed by the processing unit, causing the terminal device to perform acts comprising: receiving at least one configuration for codebook, wherein the at least one configuration for codebook comprises: a first plurality of antenna port groups and a plurality of antenna ports in one antenna port group; and transmitting, to the network device, a number of layers and at least one codebook indicator based on the at least one configuration for codebook, wherein the at least one codebook indicator comprises: one or more indicators of a plurality of second vectors, and at least one of: one or more indicators of a second plurality of antenna port groups, one or more indicators for a plurality of first amplitude coefficients, one or more indicators for a plurality of first phase coefficients, wherein a plurality of first vectors is determined based on the plurality of second vectors and at least one of the plurality of first amplitude coefficients and the plurality of first phase coefficients, wherein at least one of a length of a first vector, a number of the plurality of first vectors and a size of the one or more indicators of the plurality of second vectors is based on at least one of a number of the second plurality of antenna port groups and the plurality of first amplitude coefficients

In a fourth aspect, there is provided a source network device. The source network device comprises a processing unit; and a memory coupled to the processing unit and storing instructions thereon, the instructions, when executed by the processing unit, causing the source network device to perform acts comprising: transmitting at least one configuration for codebook, wherein the at least one configuration for codebook comprises: a first plurality of antenna port groups and a plurality of antenna ports in one antenna port group; and receiving, from the terminal device, a number of layers and at least one codebook indicator based on the at least one configuration for codebook, wherein the at least one codebook indicator comprises: one or more indicators of a plurality of second vectors, and at least one of: one or more indicators of a second plurality of antenna port groups, one or more indicators for a plurality of first amplitude coefficients, one or more indicators for a plurality of first phase coefficients, wherein a plurality of first vectors is determined based on the plurality of second vectors and at least one of the plurality of first amplitude coefficients and the plurality of first phase coefficients, wherein at least one of a length of a first vector, a number of the plurality of first vectors and a size of the one or more indicators of the plurality of second vectors is based on at least one of a number of the second plurality of antenna port groups and the plurality of first amplitude coefficients.

In a fifth aspect, there is provided a computer readable medium having instructions stored thereon, the instructions, when executed on at least one processor, causing the at least one processor to carry out the method according to any one of the first aspect, second or third aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for handover according to some embodiments of the present disclosure;

FIG. 3 is a flowchart of an example method in accordance with an embodiment of the present disclosure;

FIG. 4 is a flowchart of an example method in accordance with an embodiment of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In the following, the terms “transmission occasions”, “reception occasions”, “repetitions”, “transmission”, “reception”, “PDSCH transmission occasions”, “PDSCH repetitions”, “PUSCH transmission occasions”, “PUSCH repetitions”, “PUCCH occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “transmissions” and “receptions” can be used interchangeably. The terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably. The terms “transmission occasion”, “transmission”, “repetition”, “reception”, “reception occasion”, “monitoring occasion”, “PDCCH monitoring occasion”, “PDCCH transmission occasion”, “PDCCH transmission”, “PDCCH candidate”, “PDCCH reception occasion”, “PDCCH reception”, “search space”, “CORESET”, “multi-chance” and “PDCCH repetition” can be used interchangeably. In the following, the terms “PDCCH repetitions”, “repeated PDCCHs”, “repeated PDCCH signals”, “PDCCH candidates configured for same scheduling”, “PDCCH”, “PDCCH candidates” and “linked PDCCH candidates” can be used interchangeably. The terms “DCI” and “DCI format” can be used interchangeably. In some embodiments, the embodiments in this disclosure can be applied to PDSCH and PUSCH scheduling, and in the following, PDSCH scheduling is described as examples. For example, the embodiments in this disclosure can be applied to PUSCH by replacing “transmit” to “receive” and/or “receive” to “transmit”. The terms “PDSCH” and “PUSCH” can be used interchangeably. The terms “transmit” and “receive” can be used interchangeably. The terms “common beam”, “common beam update/indicate/indication”, “unified TCI state”, “unified TCI state update/indicate/indication”, “beam indication”, “TCI state(s) indication”, “TCI_state_r17”, “tci_StateId_r17”, “TCI_state_r17 indicating a unified TCI state”, “TCI state shared/applied for all or subset of CORESETs and UE-dedicated reception on PDSCH”, “Rel-17 TCI state”, “TCI state with tci_StateId_r17”, “TCI state configured for TCI state update in unified TCI framework”, “TCI state indicated in DCI for common beam update/indicate/indication” and “TCI state indicated in DCI and to be applied for all/subset of CORESETs and PDSCH” may be used interchangeably. The terms “subset of CORESETs”, “subset of TCI states”, “subset of unified TCI states”, “subset of downlink (unified) TCI states” and “subset of joint (unified) TCI states” may be used interchangeably. The terms “subset of PUCCHs”, “subset of TCI states”, “subset of unified TCI states”, “subset of uplink (unified) TCI states” and “subset of joint (unified) TCI states” may be used interchangeably. The terms “precoding matrix”, “precoding”, “beam”, “beamforming” and “precoder” may be used interchangeably. The terms “size” and “number of PRBs” may be used interchangeably. The terms “vector”, “beam”, “bases” and “basis” can be used interchangeably. The terms “first vector”, “first beam”, “first bases” and “first basis” can be used interchangeably. The terms “second vector”, “second beam”, “second bases” and “second basis” can be used interchangeably. The terms “third vector”, “third beam”, “third bases” and “third basis” can be used interchangeably. The terms “fourth vector”, “fourth beam”, “fourth bases” and “fourth basis” can be used interchangeably. The terms “index”, “indicator”, “indication”, “field”, “bit field” and “bitmap” can be used interchangeably. The terms “physical resource block”, “resource block”, “PRB” and “RB” can be used interchangeably. The terms “bit size”, “size of bits”, “number of bits”, “size of field” and “field size” can be used interchangeably.

As mentioned above, precoding is a generalized beamforming scheme to support multi-layer transmission in a MIMO system. Precoding is a technique that exploits transmit diversity by weighting the information stream, i.e. the transmitter sends the coded information to the receiver to achieve pre-knowledge of the channel. Using precoding, multiple streams are transmitted from the transmit antennas with independent and appropriate weighting per antenna such that the throughput is maximized at the receiver output. The terms “precoding matrix” and “precoder” may be used interchangeably hereinafter. Moreover, it may be possible that uplink transmission with 8 antenna ports can support more than 4 layers.

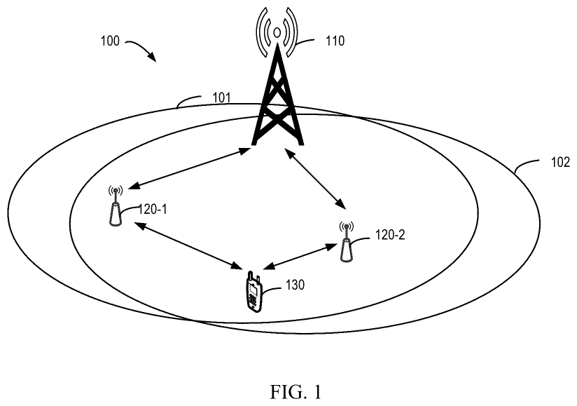

FIG. 1 illustrates an example communication network 100 in which embodiments of the present disclosure can be implemented. As shown in FIG. 1, the network 100 includes a network device 110. For example, the network device 110 may be configured with one or two or three or four TRPs/panels 120-1 and/or 120-2 and/or 120-3 and/or 120-4 (collectively referred to as TRPs 120 or individually referred to as TRP 120). The network 100 also includes a terminal device 130 served by the network device 110. The serving area of the network device 110 is called as a cell 101 and/or a cell 102. It is to be understood that the number of network devices, terminal devices and TRPs as shown in FIG. 1 is only for the purpose of illustration without suggesting any limitations to the present disclosure. The network 100 may include any suitable number of devices adapted for implementing embodiments of the present disclosure. Although not shown, it would be appreciated that one or more terminal devices may be located in the cell 101 and/or cell 102 and served by the network device 110.

In some scenarios, carrier aggregation (CA) can be supported in the network 100, in which two or more CCs are aggregated in order to support a broader bandwidth. For example, in FIG. 1, the network device 110 may provide to the terminal device 130 a plurality of serving cells including one primary cell (Pcell or Pscell or Spcell) 101 corresponding to a primary CC and at least one secondary cell (Scell) 102 corresponding to at least one secondary CC. It is to be understood that the number of network devices, terminal devices and/or serving cells is only for the purpose of illustration without suggesting any limitations to the present disclosure. The network 100 may include any suitable number of network devices, terminal devices and/or serving cells adapted for implementing implementations of the present disclosure.

In some other scenarios, the terminal device 130 may establish connections with two different network devices (not shown in FIG. 1) and thus can utilize radio resources of the two network devices. The two network devices may be respectively defined as a master network device and a secondary network device. The master network device may provide a group of serving cells, which are also referred to as “Master Cell Group (MCG)”. The secondary network device may also provide a group of serving cells, which are also referred to as “Secondary Cell Group (SCG)”. For Dual Connectivity operation, a term “Special Cell (Spcell)” may refer to the Pcell of the MCG or the primary Scell (Pscell) of the SCG depending on if the terminal device 130 is associated to the MCG or the SCG, respectively. In other cases than the Dual Connectivity operation, the term “SpCell” may also refer to the PCell.

In one embodiment, the terminal device 130 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 130 from at least one of the first network device and the second network device. In one embodiment, first information may be transmitted to the terminal device 130 from the first network device and second information may be transmitted to the terminal device 130 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, Ultra-Reliable Low latency Communication (URLLC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 130.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like. The term “TRP” refers to an antenna array (with one or more antenna elements) available to the network device located at a specific geographical location. For example, a network device may be coupled with multiple TRPs in different geographical locations to achieve better coverage. It is to be understood that the TRP can also be referred to as a “panel”, which also refers to an antenna array (with one or more antenna elements) or a group of antennas.

In one embodiment, the terminal device 130 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 130 from at least one of the first network device and the second network device. In one embodiment, first information may be transmitted to the terminal device 130 from the first network device and second information may be transmitted to the terminal device 130 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via any of the following: Radio Resource Control (RRC) signaling, Medium Access Control (MAC) control element (CE) or Downlink Control Information (DCI).

In some embodiments, the network device 110 may communicate with the terminal device 130 via a first TRP (for example, TRP 120-1) and/or a second TRP (for example, TRP 120-2) and/or a third TRP (for example, TRP 120-3) and/or a fourth TRP (for example, TRP 120-4). For example, the first TRP and/or the second TRP and/or the third TRP and/or the fourth TRP may be included in a same serving cell or different serving cells provided by the network device 110. Although some embodiments of the present disclosure are described with reference to the first TRP and/or the second TRP and/or the third TRP and/or the fourth TRP within same serving cell provided by the network device 110, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

In the communication network 100, the network device 110 can communicate data and control information to the terminal device 130 and the terminal device 130 can also communication data and control information to the network device 110. A link from the network device 110 to the terminal device 130 is referred to as a downlink (DL), while a link from the terminal device 130 to the network device 110 is referred to as an uplink (UL).

The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the first TRP and/or the second TRP and/or the third TRP and/or the fourth TRP may be explicitly associated with different higher-layer configured identities. For example, a higher-layer configured identity can be associated with a Control Resource Set (CORESET), a reference signal (RS), or a Transmission Configuration Indication (TCI) state, which is used to differentiate between transmissions between different TRPs 120 and the terminal device 130.

The term “slot” used herein refers to a dynamic scheduling unit. One slot comprises a predetermined number of symbols. For example, the number of symbols in one slot may be 12 or 14. The term “sub-slot” may refer to a number of symbols. For example, the number of symbols in one sub-slot may be 1, 2, 4, 7, 14. The sub-slot may comprise fewer symbols than one slot. The slot used herein may refer to a normal slot which comprises a predetermined number of symbols and also refer to a sub-slot which comprises fewer symbols than the predetermined number of symbols.

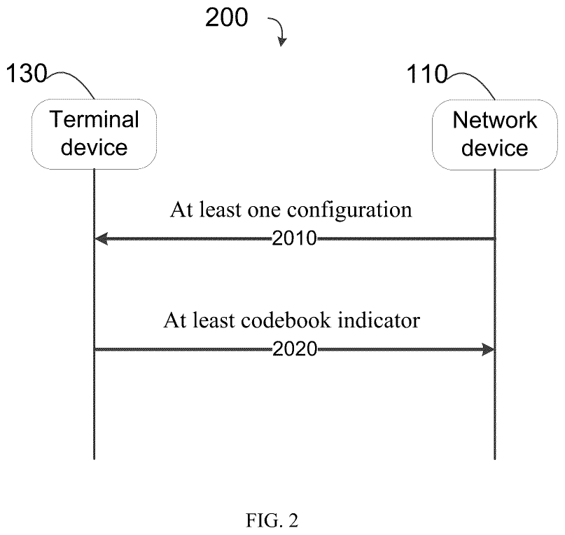

Embodiments of the present disclosure will be described in detail below. Reference is first made to FIG. 2, which shows a signaling chart illustrating process 200 among devices according to some example embodiments of the present disclosure. Only for the purpose of discussion, the process 200 will be described with reference to FIG. 1. The process 200 may involve the terminal device 130 and the network device 110 shown in FIG. 1.

In some embodiments, the network device 110 may transmit 2010 at least one configuration to the terminal device 130. In some embodiments, the terminal device 130 may transmit 2020 at least one codebook indicator to the network device 110. In some embodiments, the at least one codebook indicator may be determined based on the at least one configuration.

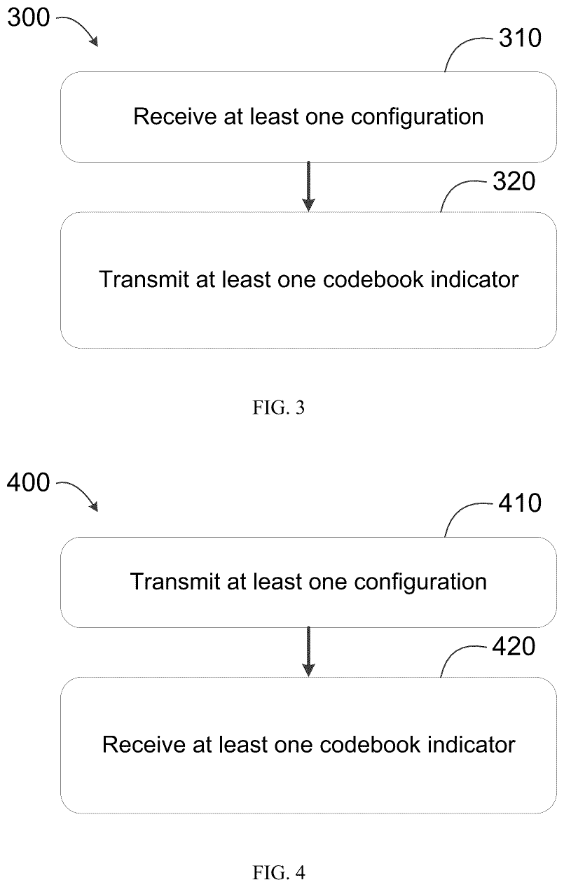

FIG. 3 shows a flowchart of an example method 300 in accordance with an embodiment of the present disclosure. The method 300 can be implemented at any suitable devices. Only for the purpose of illustrations, the method 300 can be implemented at a terminal device 130 as shown in FIG. 1.

At block 310, the terminal device 130 receives at least one configuration for codebook from the network device 110.

At block 320, the terminal device 130 transmits at least one codebook indicator, wherein the at least one codebook indicator may be determined based on the at least one configuration for codebook.

FIG. 4 shows a flowchart of an example method 400 in accordance with an embodiment of the present disclosure. The method 400 can be implemented at any suitable devices. Only for the purpose of illustrations, the method 400 can be implemented at a network device 110 as shown in FIG. 1.

At block 410, the network device 110 transmits at least one configuration for codebook to the terminal device 130.

At block 420, the network device 110 receives at least one codebook indicator from the terminal device 130.

In some embodiments, the terminal device may receive at least one configuration for codebook, wherein the at least one configuration for codebook may comprise: a first plurality of antenna port groups and a plurality of antenna ports in one antenna port group. In some embodiments, the terminal device may transmit, to the network device, a number of layers and at least one codebook indicator based on the at least one configuration for codebook. In some embodiments, the at least one codebook indicator may comprise: one or more indicators for a second plurality of antenna port groups, and one or more indicators for a plurality of first vectors. In some embodiments, at least one of a length of one first vector, a number of the plurality of first vectors and a size of the one or more indicators of the plurality of first vectors may be based on a number of the second plurality of antenna port groups.

In some embodiments, the second plurality of antenna port groups may be same as the first plurality of antenna port groups or a subset of antenna port groups selected from the first plurality of antenna port groups.

In some embodiments, the at least one codebook indicator may comprise: a field for a plurality of third amplitude coefficients corresponding to one layer with an index, a field for a plurality of third phase coefficients corresponding to one layer with the index, and at least one of: a bitmap for indicating nonzero coefficients corresponding to one layer with the index and an indicator of strongest coefficient corresponding to one layer with the index. In some embodiments, the bitmap for indicating nonzero coefficients may indicate which coefficients in the field for the plurality of third amplitude coefficients are nonzero or reported. In some embodiments, the bitmap for indicating nonzero coefficients may indicate which coefficients in the field for the plurality of third phase coefficients are nonzero or reported. In some embodiments, a size of the bitmap for indicating nonzero coefficients may be based on the number of the second plurality of antenna port groups.

In some embodiments, a size of the indicator of the strongest coefficient may be based on the number of the second plurality of antenna port groups.

In some embodiments, the at least one codebook indicator may comprise a field for a plurality of third vectors corresponding to one layer with the index, and at least one of a number of the plurality of third vectors and a length of one third vector is based on the number of the second plurality of antenna port groups.

In some embodiments, the length of one third vector may be determined based on a first parameter for codebook and a number of first subbands. In some embodiments, a value of the first parameter for codebook may be determined based on the number of the second plurality of antenna port groups.

In some embodiments, the number of the plurality of third vectors may be determined based on a third parameter for codebook, a number of second subbands and the first parameter for codebook. In some embodiments, the number of second subbands may be based on the first parameter for codebook and the number of first subbands. In some embodiments, a second size of one second subband may be determined based on the first parameter for codebook and a first size of one first subband.

In some embodiments, if the number of the second plurality of antenna port groups is 1, the value of the first parameter for codebook may be a first value. In some embodiments, if the number of the second plurality of antenna port groups is larger than 1, the value of the first parameter for codebook may be a second value. In some embodiments, the second value may be larger than or no less than the first value.

In some embodiments, if the number of the second plurality of antenna port groups is 1, the number of the plurality of first vectors may be a third value. In some embodiments, if the number of the second plurality of antenna port groups is larger than 1, the number of the plurality of first vectors may be a fourth value. In some embodiments, the fourth value may be no less than or larger than the third value.

In some embodiments, the number of the plurality of first vectors may be determined as a minimum value between the fourth value and a fifth value.

In some embodiments, the number of the plurality of first vectors may be determined as a maximum value between the third value and the fifth value. In some embodiments, the fifth value may be a first parameter of antenna port configuration multiplies a second parameter of antenna port configuration multiplies the number of the second plurality of antenna port groups. In some embodiments, a maximum number of the nonzero coefficients corresponding to one layer with the index may be determined based on the third parameter for codebook, the number of plurality of first vectors and the number of the plurality of third vectors corresponding to the first layer.

In some embodiments, the size of the one or more indicators for the plurality of first vectors may be determined based on the fifth value and the number of the plurality of first vectors or the size of the one or more indicators for the plurality of first vectors may be 0 based on the at least one configuration for codebook.

In some embodiments, a number of the plurality of antenna ports in one antenna port group may be the first parameter of antenna port configuration multiples the second parameter of antenna port configuration multiplies 2.

In some embodiments, the length of one first vector may be based on the number of the plurality of antenna ports in one antenna port group multiplies the number of the second plurality of antenna port groups and divided by 2 or based on the fifth value.

In some embodiments, the number of the first plurality of antenna port groups may be at least one of 2, 3, 4. In some embodiments, the number of the second plurality of antenna port groups may be no larger than the number of the first plurality of antenna port groups and no less than 1.

In some embodiments, the terminal device may receive a reference signal, wherein a number of antenna ports for the reference signal may be the number of the first plurality of antenna port groups multiplies the number of the plurality of antenna ports in one antenna port group. In some embodiments, at least one codebook indicator may be determined or measured based on the reference signal.

In some embodiments, the network device may transmit to the terminal device, at least one configuration for codebook, wherein the at least one configuration for codebook may comprises: a first plurality of antenna port groups and a plurality of antenna ports in one antenna port group. In some embodiments, the network device may receive, from the terminal device, a number of layers and at least one codebook indicator based on the at least one configuration for codebook. In some embodiments, the at least one codebook indicator may comprise: one or more indicators for a second plurality of antenna port groups, one or more indicators for a plurality of first vectors. In some embodiments, at least one of a length of one first vector, a number of the plurality of first vectors and a size of the one or more indicators of the plurality of first vectors may be based on a number of the second plurality of antenna port groups.

In some embodiments, the network device may transmit a reference signal, wherein a number of antenna ports for the reference signal may be the number of the first plurality of antenna port groups multiplies the number of the plurality of antenna ports in one antenna port group.

In some embodiments, the terminal device may receive at least one configuration for codebook comprising: one or more configurations for a plurality of reference signals and one or more configuration for codebook corresponding to one of the plurality of reference signals. In some embodiments, the terminal device may transmit, to the network device, a number of layers and at least one codebook indicator based on the at least one configuration for codebook. In some embodiments, the at least one codebook indicator may comprise: an indication of a reference signal from the plurality of reference signals, one or more indicators for a first plurality of antenna ports. In some embodiments, at least one of a number of the first plurality of antenna ports and a size of the one or more indicators of the first plurality of antenna ports may be based on the one or more configuration for codebook corresponding to the indication of the reference signal. In some embodiments, the one or more configuration for codebook corresponding to the indication of the reference signal may comprise a first parameter of antenna port configuration and a second parameter of antenna port configuration.

In some embodiments, the length of one third vector may be determined based on a first parameter for codebook and a number of first subbands, wherein a value of the first parameter for codebook is determined based on the one or more configuration for codebook corresponding to the indication of the reference signal.

In some embodiments, the number of the plurality of third vectors may be determined based on a third parameter for codebook, a number of second subbands and the first parameter for codebook, wherein the number of second subbands may be based on the first parameter for codebook and the number of first subbands, and a second size of one second subband may be determined based on the first parameter for codebook and a first size of one first subband.

In some embodiments, if a value of product of the first parameter of antenna port configuration and the second parameter of antenna port configuration corresponding to an indication of a first reference signal, the value of the first parameter for codebook may be a first value. In some embodiments, if the value of product of the first parameter of antenna port configuration and the second parameter of antenna port configuration corresponding to an indication of a second reference signal, the value of the first parameter for codebook may be a second value.

In some embodiments, if the value of product of the first parameter of antenna port configuration and the second parameter of antenna port configuration corresponding to an indication of the first reference signal, the number of the first plurality of antenna ports may be a third value.

In some embodiments, if the value of product of the first parameter of antenna port configuration and the second parameter of antenna port configuration corresponding to an indication of the second reference signal, the number of the first plurality of antenna ports may be a fourth value.

In some embodiments, the number of the first plurality of antenna ports may be determined as a minimum value between the fourth value and a fifth value. In some embodiments, the number of the first plurality of antenna ports may be determined as a maximum value between the third value and the fifth value, wherein the fifth value may be the first parameter of antenna port configuration multiplies the second parameter of antenna port configuration.

In some embodiments, the size of the one or more indicators of the first plurality of antenna ports may be determined based on the fifth value and the value of the number of the first plurality of antenna ports.

In some embodiments, the terminal device may receive the reference signal based on the one or more configuration for codebook corresponding to the indication of the reference signal.

In some embodiments, the network device may transmit to a terminal device, at least one configuration for codebook comprising: one or more configurations for a plurality of reference signals and one or more configuration for codebook corresponding to one reference signal. In some embodiments, the network device may receive, from the terminal device, a number of layers and at least one codebook indicator based on the at least one configuration for codebook. In some embodiments, the at least one codebook indicator may comprise: an indication of a reference signal, one or more indicators for a first plurality of antenna ports, wherein at least one of a number of the first plurality of antenna ports and a size of the one or more indicators of the first plurality of antenna ports is based on the one or more configuration for codebook corresponding to the indication of the reference signal, wherein the one or more configuration for codebook corresponding to the indication of the reference signal comprises a first parameter of antenna port configuration and a second parameter of antenna port configuration.

In some embodiments, the network device may transmit the plurality of reference signals based on the one or more configuration for codebook corresponding to one reference signal.

In some embodiments, the terminal device may receive, at least one configuration for codebook. In some embodiments, the at least one configuration for codebook may comprise: a first plurality of antenna port groups and a plurality of antenna ports in one antenna port group. In some embodiments, the terminal device may transmit, to the network device, a number of layers and at least one codebook indicator based on the at least one configuration for codebook. In some embodiments, the at least one codebook indicator may comprise: one or more indicators of a plurality of second vectors, and at least one of: one or more indicators of a second plurality of antenna port groups, one or more indicators for a plurality of first amplitude coefficients, one or more indicators for a plurality of first phase coefficients.

In some embodiments, a plurality of first vectors may be determined based on the plurality of second vectors and at least one of the plurality of first amplitude coefficients and the plurality of first phase coefficients. In some embodiments, at least one of a length of a first vector, a number of the plurality of first vectors and a size of the one or more indicators of the plurality of second vectors may be based on at least one of a number of the second plurality of antenna port groups and the plurality of first amplitude coefficients.

In some embodiments, the second plurality of antenna port groups may be same as the first plurality of antenna port groups or a subset of antenna port groups selected from the first plurality of antenna port groups.

In some embodiments, at least one of a number of the plurality of first amplitude coefficients and a number of the plurality of first phase coefficients may be determined based on the number of the second plurality of antenna port groups. In some embodiments, the second plurality of antenna port groups may be determined based on values of the plurality of first amplitude coefficients.

In some embodiments, the at least one codebook indicator may comprise: a field for a plurality of third amplitude coefficients corresponding to one layer with an index, a field for a plurality of third phase coefficients corresponding to one layer with the index, and at least one of: a bitmap for indicating nonzero coefficients corresponding to one layer with the index and an indicator of strongest coefficient corresponding to one layer with the index.

In some embodiments, the bitmap for indicating nonzero coefficients may indicate which coefficients in the field for the plurality of third amplitude coefficients are nonzero or reported, and the bitmap may indicate which coefficients in the field for the plurality of third phase coefficients are nonzero or reported, and a size of the bitmap may be based on at least one of the number of the second plurality of antenna port groups and the plurality of first amplitude coefficients. In some embodiments, a size of the indicator of the strongest coefficient may be based on at least one of the number of the second plurality of antenna port groups and the plurality of first amplitude coefficients.

In some embodiments, the at least one codebook indicator may comprise one or more indicators for a plurality of third vectors corresponding to one layer with the index, and at least one of a number of the plurality of third vectors and a length of one third vector may be based on at least one of the number of the second plurality of antenna port groups and the plurality of first amplitude coefficients. In some embodiments, the length of one third vector may be determined based on a first parameter for codebook and a number of first subbands. In some embodiments, a value of the first parameter for codebook may be determined based on at least one of the number of the second plurality of antenna port groups and the plurality of first amplitude coefficients. In some embodiments, the number of the plurality of third vectors may be determined based on a third parameter for codebook, a number of second subbands and the first parameter for codebook. In some embodiments, the number of second subbands may be based on the first parameter for codebook and the number of first subbands, and a second size of one second subband is determined based on the first parameter for codebook and a first size of one first subband.

In some embodiments, the at least one codebook indicator may comprise one or more indicators for a plurality of fourth vectors, wherein the plurality of fourth vectors corresponds to one layer with the index or the plurality of fourth vectors may be same for each layer of the number of layers.

In some embodiments, at least one of a number of the plurality of fourth vectors and a length of one fourth vector may be based on at least one of the number of the second plurality of antenna port groups and the plurality of first amplitude coefficients. In some embodiments, the length of one fourth vector may be determined based on a fourth parameter for codebook and either one of the number of first subbands or the number of second subbands. In some embodiments, a value of the fourth parameter may be determined based on at least one of the number of the second plurality of antenna port groups and the plurality of first amplitude coefficients. In some embodiments, the number of the plurality of fourth vectors may be determined based on a sixth parameter for codebook, a number of third subbands and the fourth parameter for codebook. In some embodiments, the number of third subbands may be based on the fourth parameter for codebook and either one of the number of first subbands or the number of second subbands. In some embodiments, a third size of one third subband may be determined based on the fourth parameter for codebook and either one of the first size of one first subband or a second size of one second subband.

In some embodiments, the plurality of fourth vectors may be same as the plurality of third vectors. In some embodiments, the fourth parameter may be same as the first parameter. In some embodiments, the sixth parameter may be same as the third parameter.

In some embodiments, if a value of first amplitude coefficient corresponding to an antenna port group is 0, the antenna port group may not be comprised in the second plurality of antenna port groups.

In some embodiments, if the number of the second plurality of antenna port groups is 1, the value of the first parameter for codebook may be a first value. In some embodiments, if the number of the second plurality of antenna port groups is 1, the value of the third parameter for codebook may be a sixth value. In some embodiments, if the number of the second plurality of antenna port groups is larger than 1, the value of the first parameter for codebook may be a second value. In some embodiments, the second value may be no less than or larger than the first value. In some embodiments, if the number of the second plurality of antenna port groups is larger than 1, the value of the third parameter for codebook may be a seventh value. In some embodiments, the seventh value may be larger than or no less than the sixth value.

In some embodiments, if the number of the second plurality of antenna port groups is 1, the number of the plurality of second vectors may be an eighth value. In some embodiments, if the number of the second plurality of antenna port groups is larger than 1, the second number of the plurality of second vectors may be a ninth value. In some embodiments, the ninth value may be no less than or larger than the eighth value. In some embodiments, the number of the plurality of second vectors may be determined as a minimum value between the ninth value and a tenth value. In some embodiments, the number of the plurality of second vectors may be determined as a maximum value between the eighth value and the tenth value. In some embodiments, the tenth value may be a first parameter of antenna port configuration multiplies a second parameter of antenna port configuration multiplies the number of the second plurality of antenna port groups. In some embodiments, a maximum number of the nonzero coefficients corresponding to one layer with the index may be determined based on the third parameter for codebook, the number of the plurality of second vectors and the number of the plurality of third vectors corresponding to the first layer.

In some embodiments, the number of the plurality of second vectors may be determined based on a number of second vectors corresponding to one antenna port group and the number of the second plurality of antenna port groups, wherein the number of second vectors corresponding to one antenna port group may be based on the at least one configuration for codebook.

In some embodiments, the number of the plurality of first vectors may be based on or same as the number of second vectors corresponding to one antenna port group.

In some embodiments, one indicator of the one or more indicators of the plurality of second vectors may indicate the number of second vectors corresponding to one antenna port group or a group of second vectors for one first vector. In some embodiments, a number of the group of second vectors may be based on the number of the second plurality of antenna port groups.

In some embodiments, a size of the one or more indicators of the plurality of second vectors or a number of the one or more indicators of the plurality of second vectors may be determined based on the tenth value and the number of second vectors corresponding to one antenna port group and either one of the number of the second plurality of antenna port groups or the plurality of first amplitude coefficients.

In some embodiments, a number of the plurality of antenna ports in one antenna port group may be the first parameter of antenna port configuration multiples the second parameter of antenna port configuration multiplies 2.

In some embodiments, the length of one first vector may be based on the number of the plurality of antenna ports in one antenna port group multiplies the number of the second plurality of antenna port groups and divided by 2 or based on the tenth value.

In some embodiments, the number of the first plurality of antenna port groups may be at least one of 2, 3, 4. In some embodiments, the number of the second plurality of antenna port groups may be no larger than the number of the first plurality of antenna port groups and no less than 1.

In some embodiments, the terminal device may a reference signal, wherein a number of antenna ports for the reference signal may be the number of the first plurality of antenna port groups multiplies the number of the plurality of antenna ports in one antenna port group.

In some embodiments, the network device may transmit to the terminal device, at least one configuration for codebook, wherein the at least one configuration for codebook may comprise: a first plurality of antenna port groups and a plurality of antenna ports in one antenna port group. In some embodiments, the network device may receive from the terminal device, a number of layers and at least one codebook indicator based on the at least one configuration for codebook. In some embodiments, the at least one codebook indicator may comprise: one or more indicators of a plurality of second vectors, and at least one of: one or more indicators of a second plurality of antenna port groups, one or more indicators for a plurality of first amplitude coefficients, one or more indicators for a plurality of first phase coefficients. In some embodiments, a plurality of first vectors may be determined based on the plurality of second vectors and at least one of the plurality of first amplitude coefficients and the plurality of first phase coefficients, wherein at least one of a length of a first vector, a number of the plurality of first vectors and a size of the one or more indicators of the plurality of second vectors is based on at least one of a number of the second plurality of antenna port groups and the plurality of first amplitude coefficients.

In some embodiments, the network device may transmit a reference signal, wherein a number of antenna ports for the reference signal may be the number of the first plurality of antenna port groups multiplies the number of the plurality of antenna ports in one antenna port group.

In some embodiments, the terminal device may receive at least one configuration for codebook, wherein the at least one configuration for codebook may include at least one of: a first plurality of antenna port groups, a plurality of antenna ports in one antenna port group, at least one parameter for antenna port, a configuration for codebook type, a configuration for reporting type, at least one parameter for codebook, a number of physical resource blocks (PRBs) in a bandwidth part (BWP), a number of a plurality of first subbands, a size of one first subband, a number of PRBs of one first subband, a number of a plurality of second subbands (e.g. represented as N₃), a size of one second subband, a number of PRBs of one second subband, a number of a plurality of third subbands (e.g. represented as N₄), a size of one third subband, a number of PRBs of one third subband, a number of a plurality of first vectors (e.g. represented as L), a number of a plurality of second vectors (e.g. represented as Lₜ), a number of a plurality of third vectors (e.g. represented as Mᵥ), a number of a plurality of fourth vectors (e.g. represented as M_{w}), a first parameter for codebook (e.g. represented as R), a second parameter for codebook (e.g. represented as pᵥ), a third parameter for codebook (e.g. represented as β), a fourth parameter for codebook (e.g. represented as R_{w}), a fifth parameter for codebook (e.g. represented as p_{v,w}), and a sixth parameter for codebook (e.g. represented as β_{w}).

In some embodiments, the terminal device may be configured with a number of PRBs for a bandwidth part (BWP) or with a size for the BWP. In some embodiments, the number of PRBs for the BWP (e.g. represented as N_{BWP}^{size}) may be a positive integer. For example, N_{BWP} may be a positive integer. For example, 24≤N_{BWP}^{size}≤275.

In some embodiments, the terminal device may be configured with a starting position of the BWP (e.g. represented as N_{BWP}^{start}). For example, N_{BWP}^{start} may be a non-negative integer. For example, 0≤N_{BWP}^{start}≤275.

In some embodiments, the starting position of the BWP and the number of PRBs for the BWP may be configured in one higher layer parameter.

In some embodiments, first subband may correspond to a subband for channel quality indicator (CQI) or CQI subband or CSI subband.

In some embodiments, the size of one first subband or the number of PRBs of one first subband may be represented as N_{PRB}^{SB}, and N_{PRB}^{SB} is a positive integer. For example, 1≤N_{PRB}^{SB}≤32. For example, N_{PRB}^{SB} may be at least one of {4, 8, 16, 32}. In some embodiments, N_{PRB}^{SB} may be based on the value of N_{BWP}. In some embodiments, if 24≤N_{BWP}≤72, N_{PRB}^{SB} may be 4 or 8. For example, N_{PRB}^{SB} may be configured to be 4 or 8 based on one higher layer parameter for subband. In some embodiments, if 73≤N_{BWP}≤144, N_{PRB}^{SB} may be 8 or 16. For example, N_{PRB}^{SB} may be configured to be 8 or 16 based on the higher layer parameter for subband. In some embodiments, if 145≤N_{BWP}≤275, N_{PRB}^{SB} may be 16 or 32. For example, N_{PRB}^{SB} may be configured to be 16 or 32 based on the higher layer parameter for subband.

In some embodiments, the at least one parameter for antenna port may comprise at least one of: a first plurality of antenna port groups, a number of the first plurality of antenna port groups, a number of antenna ports in one antenna port group, one or more subsets of antenna ports in one antenna port group, a number of the one or more subsets of antenna ports in one antenna port group, a number of antenna ports in one subset of antenna ports, a plurality of antenna ports in one subset of antenna ports, a plurality of antenna ports in one antenna port group, a first parameter of antenna port configuration and a second parameter of antenna port configuration. For example, one antenna port group may correspond to a TRP or antenna ports of a TRP. In some embodiments, one antenna port group may correspond to one CSI-RS resource. In some embodiments, the at least one configuration for codebook may comprise the first plurality of antenna port groups.

In some embodiments, a number of the first plurality of antenna port groups (e.g. represented as T₁) may be at least one of {1, 2, 3, 4} or {1, 2, 4} or {2, 3, 4} or {2, 4}. In some embodiments, a number of the second plurality of antenna port groups (e.g. represented as Tₛ.) may be at least one of {1, 2, 3, 4} or {1, 2, 4} or {2, 3, 4} or {2, 4}. In some embodiments, the number of the second plurality of antenna port groups Tₛ may be 1≤Tₛ≤T₁. For example, if T₁=2, Tₛ may be 1 or 2. For another example, if T₁=4, Tₛ may be 1 or 2 or 4. For another example, if T₁=4, Tₛ may be 1 or 2 or 3 or 4. For another example, if T₁=4, Tₛ may be 1 or 4. For another example, if T₁=3, Tₛ may be 1 or 2 or 3. For another example, if T₁=3, Tₛ may be 1 or 3.

In some embodiments, the at least one configuration for codebook may comprise the plurality of antenna ports in one antenna port group. In some embodiments, a number of the plurality of antenna ports in one antenna port group (e.g. represented as P) may be at least one of {1, 2, 4, 6, 8, 12, 16}. In some embodiments, number of antenna ports in each antenna port group may be same. For example, P may be a positive integer. For example, P may be at least one of {1, 2, 4, 6, 8, 12, 16}.

In some embodiments, there may be one or more reference signals, wherein a number of antenna ports for one of the one or more reference signals may equal to the number of the first plurality of antenna port groups multiplies the number of the plurality of antenna ports in one antenna port group. In some embodiments, the reference signal may be at least one of: a channel state information reference signal (CSI-RS), a sounding reference signal (SRS), a demodulation reference signal (DMRS), a CSI-RS for tracking and a phase tracking reference signal (PTRS). In some embodiments, the number of antenna ports for one of the one or more reference signals (e.g. represented as Pₜₒₜ) may be a positive integer. For example, Pₜₒₜ may be a positive integer. For example, 2<=Pₜₒₜ<=32. In some embodiments, Pₜₒₜ may be at least one of {2, 4, 8, 12, 16, 24, 32}. In some embodiments, Pₜₒₜ=P*T₁.

In some embodiments, the terminal device may receive the reference signal based on the number of antenna ports for the reference signal.

In some embodiments, an index of one antenna port group may be represented as t, t may be a non-negative integer. For example, 1≤t≤T₁. For another example, 0≤t≤T₁−1. For another example, 0≤t≤Tₛ−1. For another example, 1≤t≤Tₛ. In some embodiments, the antenna port group with index t may comprise Pₜ antenna ports. For example, Pₜ may be a positive integer. For example, Pₜ may be at least one of {1, 2, 4, 6, 8, 12, 16}. In some embodiments, for different values of t or for different antenna port groups with different indexes, the values of Pₜ may be different. In some embodiments, for each antenna port group, the values of Pₜ may be same. For example, Pₜ=P. In some embodiments, Pₜₒₜ=Σₜ₌₀^{T-1}Pₜ.

In some embodiments, the antenna port group with index t may comprise N_{g,t} subsets of antenna ports. For example, N_{g,t} may be a positive integer. For example, N_{g,t} may be at least one of {1, 2, 3, 4}. For example, each subset of antenna ports may correspond to a panel or antenna ports of a panel. In some embodiments, for different values of t or for different antenna port groups with different indexes, the values of N_{g,t} may be different. In some embodiments, for each antenna port group, the values of N_{g,t} may be same. In some embodiments, each subset of antenna ports may comprise Pₜ antenna ports. In some embodiments, Pₜₒₜ=Σₜ₌₀^{T-1}N_{g,t}·Pₜ.

In some embodiments, a value of the first parameter of antenna port configuration may be represented as N₁. For example, N₁ may be a positive integer. For example, N₁ may be at least one of {2, 3, 4, 6, 8, 12, 16}. In some embodiments, a value of the second parameter of antenna port configuration may be represented as N₂. For example, N₂ may be a positive integer. For example, N₂ may be at least one of {1, 2, 3, 4}. In some embodiments, the first parameter of antenna port configuration and the second parameter of antenna port configuration may be configured in one higher layer parameter.

In some embodiments, the number of antenna ports in one antenna port group may be determined based on the first parameter of antenna port configuration and a second parameter of antenna port configuration. In some embodiments, the number of antenna ports in one antenna port group may be Pₜ=N_{g,t}·N₁·N₂·2 or P=N_{g,t}·N₁·N₂·2.

In some embodiments, the number of antenna ports in one subset of antenna ports of one antenna port group may be determined based on the first parameter of antenna port configuration and a second parameter of antenna port configuration. In some embodiments, the number of antenna ports in one subset of antenna ports of one antenna port group may be Pₜ=N₁·N₂·2 or P=N₁·N₂·2. In some embodiments, the number of antenna ports in one antenna port group may be Pₜ=N₁·N₂·2 or P=N₁·N₂·2.

In some embodiments, the number of antenna ports for the reference signal may be determined based on the first parameter of antenna port configuration and a second parameter of antenna port configuration. In some embodiments, the number of antenna ports for the reference signal may be Pₜₒₜ=N₁·N₂·2 or Pₜₒₜ=T₁·N₁·N₂·2.

In some embodiments, there may be a parameter “O₁”, and “O₁” may represent a first discrete fourier transform (DFT) oversampling in the first dimension. For example, “O₁” may be at least one of {1, 2, 4}. For another example, “O₁” may be 2 or 4. In some embodiments, there may be a parameter “O₂”, and “O₂” may represent a second DFT oversampling in the second dimension. For example, “O₂” may be at least one of {1, 2, 4}. 5 For another example, “O₂” may be 2 or 4.

In some embodiments, one configuration of (N₁, N₂) may correspond to one configuration of (O₁, O₂). In some embodiments, one configuration of (O₁, O₂) may correspond to one configuration of (N₁, N₂).

In some embodiments, the configurations of (N₁, N₂) and (O₁, O₂) and/or Pₜₒₜ or Pₜ or P may be at least one of row and/or column in the following Table 1.

TABLE 1

| Pₜₒₜ or Pₜ or P | (N₁, N₂) | (O₁, O₂) |
|---|---|---|
| 2 | (1, 1) or (N/A, N/A) | (1, 1) or (N/A, N/A) |
| 4 | (2, 1) | (4, 1) |
| 8 | (2, 2) | (4, 4) |
| 8 | (4, 1) | (4, 1) |
| 12 | (3, 2) | (4, 4) |
| 12 | (6, 1) | (4, 1) |
| 16 | (4, 2) | (4, 4) |
| 16 | (8, 1) | (4, 1) |
| 24 | (4, 3) | (4, 4) |
| 24 | (6, 2) | (4, 4) |
| 24 | (12, 1) | (4, 1) |
| 32 | (4, 4) | (4, 4) |
| 32 | (8, 2) | (4, 4) |
| 32 | (16, 1) | (4, 1) |

In some embodiments, N/A may represent no value or no configuration of a parameter.

In some embodiments, one configuration of (N_{g,t}, N₁, N₂) may correspond to one configuration of (O₁, O₂). In some embodiments, one configuration of (O₁, O₂) may correspond to one configuration of (N_{g,t}, N₁, N₂).

In some embodiments, the configurations of (N_{g,t}, N₁, N₂) and (O₁, O₂) and/or Pₜₒₜ or Pₜ or P may be at least one of row and/or column in the following Table 2.

TABLE 2

| Pₜₒₜ or Pₜ or P | (N_{g, t}, N₁, N₂) | (O₁, O₂) |
|---|---|---|
| 8 | (2, 2, 1) | (4, 1) |
| 16 | (2, 4, 1) | (4, 1) |
| 16 | (4, 2, 1) | (4, 1) |
| 16 | (2, 2, 2) | (4, 4) |
| 32 | (2, 8, 1) | (4, 1) |
| 32 | (4, 4, 1) | (4, 1) |
| 32 | (2, 4, 2) | (4, 4) |
| 32 | (4, 2, 2) | (4, 4) |

In some embodiments, the configurations of T₁ and/or (N₁, N₂) and/or (O₁, O₂) and/or Pₜₒₜ and/or Pₜ or P may be at least one of row and/or column in the following Table 3. For example, Pₜ=N₁·N₂·2 or P=N₁·N₂·2.

TABLE 3

| Pₜₒₜ | Pₜ or P | T₁ | (N₁, N₂) | (O₁, O₂) |
|---|---|---|---|---|
| 4 | 2 | 2 | (1, 1) or (N/A, N/A) | (1, 1) or (N/A, N/A) |
| 8 | 2 | 4 | (1, 1) or (N/A, N/A) | (1, 1) or (N/A, N/A) |
| 8 | 4 | 2 | (2, 1) | (4, 1) |
| 12 | 4 | 3 | (2, 1) | (4, 1) |
| 16 | 4 | 4 | (2, 1) | (4, 1) |
| 16 | 8 | 2 | (4, 1) | (4, 1) |
| 16 | 8 | 2 | (2, 2) | (4, 4) |
| 24 | 8 | 3 | (4, 1) | (4, 1) |
| 24 | 8 | 3 | (2, 2) | (4, 4) |
| 24 | 12 | 2 | (6, 1) | (4, 1) |
| 24 | 12 | 2 | (3, 2) | (4, 4) |
| 32 | 8 | 4 | (4, 1) | (4, 1) |
| 32 | 8 | 4 | (2, 2) | (4, 4) |
| 32 | 16 | 2 | (8, 1) | (4, 1) |
| 32 | 16 | 2 | (4, 2) | (4, 4) |

In some embodiments, the configurations of T₁ and/or (N₁, N₂) and/or (O₁, O₂) and/or Pₜₒₜ and/or Pₜ or P may be at least one of row and/or column in the following Table 4. For example, Pₜₒₜ=N₁·N₂·2.

TABLE 4

| Pₜₒₜ | Pₜ or P | T₁ | (N₁, N₂) | (O₁, O₂) |
|---|---|---|---|---|
| 4 | 2 | 2 | (2, 1) | (4, 1) |
| 8 | 2 | 4 | (4, 1) | (4, 1) |
| 8 | 2 | 4 | (2, 2) | (4, 4) |
| 8 | 4 | 2 | (4, 1) | (4, 1) |
| 8 | 4 | 2 | (2, 2) | (4, 4) |
| 12 | 4 | 3 | (3, 2) | (4, 4) |
| 12 | 4 | 3 | (6, 1) | (4, 1) |
| 16 | 4 | 4 | (4, 2) | (4, 4) |
| 16 | 4 | 4 | (8, 1) | (4, 1) |
| 16 | 8 | 2 | (4, 2) | (4, 4) |
| 16 | 8 | 2 | (8, 1) | (4, 1) |
| 24 | 8 | 3 | (4, 3) | (4, 4) |
| 24 | 8 | 3 | (6, 2) | (4, 4) |
| 24 | 8 | 3 | (12, 1) | (4, 1) |
| 24 | 12 | 2 | (4, 3) | (4, 4) |
| 24 | 12 | 2 | (6, 2) | (4, 4) |
| 24 | 12 | 2 | (12, 1) | (4, 1) |
| 32 | 8 | 4 | (4, 4) | (4, 4) |
| 32 | 8 | 4 | (8, 2) | (4, 4) |
| 32 | 8 | 4 | (16, 1) | (4, 1) |
| 32 | 16 | 2 | (4, 4) | (4, 4) |
| 32 | 16 | 2 | (8, 2) | (4, 4) |
| 32 | 16 | 2 | (16, 1) | (4, 1) |

In some embodiments, the configurations of T₁ and/or (N₁, N₂) and/or (O₁, O₂) and/or Pₜₒₜ and/or Pₜ or P may be at least one of row and/or column in the following Table 5. For example, Pₜₒₜ=N₁·N₂·2.

TABLE 5

| Pₜₒₜ | Pₜ or P | T₁ | (N₁, N₂) | (O₁, O₂) |
|---|---|---|---|---|
| 8 | 4 | 2 | (2, 2) | (4, 4) or (4, 1) or (4, 2) |
| 12 | 4 | 3 | (3, 2) | (4, 4) or (1, 4) or (2, 4) |
| 16 | 4 | 4 | (4, 2) | (4, 4) or (4, 1) or (4, 2) |
| 16 | 8 | 2 | (4, 2) | (4, 4) or (4, 1) or (4, 2) |
| 24 | 8 | 3 | (4, 3) | (4, 4) or (4, 1) or (4, 2) |
| 24 | 12 | 2 | (6, 2) | (4, 4) or (4, 1) or (4, 2) |
| 24 | 12 | 2 | (12, 1) | (4, 1) |
| 32 | 8 | 4 | (4, 4) | (4, 4) or (4, 1) or (4, 2) |
| 32 | 16 | 2 | (8, 2) | (4, 4) or (4, 1) or (4, 2) |
| 32 | 16 | 2 | (16, 1) | (4, 1) |

In some embodiments, the configurations of T₁ and/or (N_{g,t}, N₁, N₂) and/or (O₁, O₂) and/or Pₜₒₜ and/or Pₜ or P may be at least one of row and/or column in the following Table 6.

TABLE 6

| Pₜₒₜ | T₁ | (N_{g, t}, N₁, N₂) | (O₁, O₂) |
|---|---|---|---|
| 8 | 2 | (2, 1, 1) or (2, N/A, N/A) | (1, 1) or (N/A, N/A) |
| 16 | 2 | (2, 2, 1) | (4, 1) |
| 32 | 4 | (2, 2, 1) | (4, 1) |
| 32 | 2 | (2, 4, 1) | (4, 1) |
| 32 | 2 | (4, 2, 1) | (4, 1) |
| 32 | 2 | (2, 2, 2) | (4, 4) |

In some embodiments, there may be a vector uₘ. In some embodiments, uₘ may be a DFT vector. In some embodiments, if N₂>1,

$${u}_{m} = [ 1 , {e}^{j \frac{2 π m}{{O}_{2} {N}_{2}}} , … , {e}^{j \frac{2 π m ( {N}_{2} - 1 )}{{O}_{2} {N}_{2}}} ] .$$

In some embodiments, if N₂=2,

$${u}_{m} = [ 1 , {e}^{j \frac{2 π m}{{O}_{2} {N}_{2}}} ] .$$

In some embodiments, if N₂=1, uₘ=1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, there may be a vector v_{l,m}. In some embodiments,

$${v}_{l , m} = {[ {u}_{m} , {u}_{m} * {e}^{j \frac{2 π l}{{O}_{1} {N}_{1}}} , … , {u}_{m} * {e}^{j \frac{2 π l ( {N}_{1} - 1 )}{{O}_{1} {N}_{1}}} ]}^{T} .$$

In some embodiments, if N₁=2 and N₂=2,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, if N₁=4 and N₂=1,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, l may be a non-negative integer. For example, 0≤l≤O₁N₁. For another example, l may be at least one of {0, 2, 4, 6, 8}. For another example, l may be at least one of {0, 1, 2, 3}. For another example, l may be 0 or 1. In some embodiments, [ ]^{T} may represent a transposition of a vector or a matrix.

In some embodiments, the terminal device may determine or report a number of layers and at least one codebook indicator based on the at least one configuration for codebook to the network device. In some embodiments, the number of layers (e.g. represented as vᵣᵢ) may be at least one of {1, 2} or {1, 2, 3, 4} or {1, 2, 3, 4, 5, 6, 7, 8}. In some embodiments, there may be a plurality of layers, and each layer may be with an index, wherein the index of a layer may be represented as r, r may be non-negative integer. For example, 1≤r≤vᵣᵢ. For example, r may be at least one of {1, 2, . . . vᵣᵢ} or {1, 2} or {1, 2, 3, 4} or {1, 2, 3, 4, 5, 6, 7, 8}.

In some embodiments, the at least one codebook indicator may comprise at least one of: one or more indicators (or a field) for a first plurality of antenna port groups, one or more indicators (or a field) for a second plurality of antenna port groups, one or more indicators (or a field) for a plurality of first vectors, one or more indicators (or one or more fields) for a plurality of second vectors, one or more indicators (or a field) for a first plurality of rotations for the plurality of first vectors, one or more indicators (or one or more fields) for a second plurality of rotations for the plurality of second vectors, one or more indicators (or a field) for a plurality of third vectors, one or more indicators (or a field) for a plurality of fourth vectors, an indicator (or a field) for a strongest coefficient, one or more indicators (or one or more indexes or one or more fields) for a first antenna port group, one or more indicators (or a field) for a plurality of first amplitude coefficients, one or more indicators (or a field) for a plurality of first phase coefficients, one or more indicators (or a field) for a plurality of second amplitude coefficients, one or more indicators (or a field) for a plurality of second phase coefficients, one or more indicators (or a field) for a plurality of third amplitude coefficients, one or more indicators (or a field) for a plurality of third phase coefficients, a first number of nonzero coefficients, one or more indicators (or one or more bitmaps) for indicating nonzero coefficients.

In some embodiments, the one or more indicators (or one or more bitmaps) for indicating nonzero coefficients may indicate indexes of third amplitude coefficients and/or indicating indexes of third phase coefficients, and values of the third amplitude coefficients corresponding to the indexes and/or the third phase coefficients corresponding to the indexes may be nonzero. In some embodiments, the one or more indicators (or one or more bitmaps) for indicating nonzero coefficients may indicate which coefficients in the one or more indications or in the field for the plurality of third amplitude coefficients are nonzero or reported. In some embodiments, the one or more indicators (or one or more bitmaps) for indicating nonzero coefficients may indicate which coefficients in the one or more indications or in the field for the plurality of third phase coefficients are nonzero or reported.

In some embodiments, one or more of the at least one codebook indicator may be same or applied for each layer of the number of layers. For example, layer common. In some embodiments, one or more of the at least one codebook indicator may correspond to one layer with an index. For example, layer specific.

In some embodiments, the one or more indicators (or the field) for the second plurality of antenna port groups may be same or applied for each layer of the number of layers. For example, layer common. In some embodiments, the one or more indicators (or the field) for the second plurality of antenna port groups may correspond to one layer with an index. For example, layer specific.

In some embodiments, the one or more indicators (or the field) for the plurality of first vectors may be same or applied for each layer of the number of layers. For example, layer common. In some embodiments, the one or more indicators (or the field) for the plurality of first vectors may correspond to one layer with an index. For example, layer specific.

In some embodiments, the one or more indicators (or the field) for the plurality of second vectors may be same or applied for each layer of the number of layers. For example, layer common. In some embodiments, the one or more indicators (or the field) for the plurality of second vectors may correspond to one layer with an index. For example, layer specific.

In some embodiments, the one or more indicators (or the field) for the first plurality of rotations for the plurality of first vectors may be same or applied for each layer of the number of layers. For example, layer common. In some embodiments, the one or more indicators (or the field) for the first plurality of rotations for the plurality of first vectors may correspond to one layer with an index. For example, layer specific.

In some embodiments, the one or more indicators (or the field) for the second plurality of rotations for the plurality of second vectors may be same or applied for each layer of the number of layers. For example, layer common. In some embodiments, the one or more indicators (or the field) for the second plurality of rotations for the plurality of second vectors may correspond to one layer with an index. For example, layer specific.

In some embodiments, the one or more indicators (or the field) for the plurality of third vectors may be same or applied for each layer of the number of layers. For example, layer common. In some embodiments, the one or more indicators (or the field) for the plurality of third vectors may correspond to one layer with an index. For example, layer specific.

In some embodiments, the one or more indicators (or the field) for the plurality of fourth vectors may be same or applied for each layer of the number of layers. For example, layer common. In some embodiments, the one or more indicators (or the field) for the plurality of fourth vectors may correspond to one layer with an index. For example, layer specific.

In some embodiments, the indicator (or the field) for the strongest coefficient may be same or applied for each layer of the number of layers. For example, layer common. In some embodiments, the indicator (or the field) for the strongest coefficient may correspond to one layer with an index. For example, layer specific.

In some embodiments, the one or more indicators (or the field) for the plurality of first amplitude coefficients may be same or applied for each layer of the number of layers. For example, layer common. In some embodiments, the one or more indicators (or the field) for the plurality of first amplitude coefficients may correspond to one layer with an index. For example, layer specific.

In some embodiments, the one or more indicators (or the field) for the plurality of first phase coefficients may be same or applied for each layer of the number of layers. For example, layer common. In some embodiments, the one or more indicators (or the field) for the plurality of first phase coefficients may correspond to one layer with an index. For example, layer specific.

In some embodiments, the one or more indicators (or the field) for the plurality of second amplitude coefficients may be same or applied for each layer of the number of layers. For example, layer common. In some embodiments, the one or more indicators (or the field) for the plurality of second amplitude coefficients may correspond to one layer with an index. For example, layer specific.

In some embodiments, the one or more indicators (or the field) for the plurality of second phase coefficients may be same or applied for each layer of the number of layers. For example, layer common. In some embodiments, the one or more indicators (or the field) for the plurality of second phase coefficients may correspond to one layer with an index. For example, layer specific.

In some embodiments, the one or more indicators (or the field) for the plurality of third amplitude coefficients may correspond to one layer with an index. For example, layer specific. In some embodiments, the one or more indicators (or the field) for the plurality of third phase coefficients may correspond to one layer with an index. For example, layer specific.

In some embodiments, the one or more indicators (or the field) for indicating nonzero coefficients may be same or applied for each layer of the number of layers. For example, layer common. In some embodiments, the one or more indicators (or the field) for indicating nonzero coefficients may correspond to one layer with an index. For example, layer specific.

In some embodiments, the first number of nonzero coefficients may be same or applied for each layer of the number of layers. For example, layer common. In some embodiments, the first number of nonzero coefficients may correspond to one layer with an index. For example, layer specific.

In some embodiments, the number of the plurality of first vectors, the second parameter for codebook and the third parameter for codebook may be configured or indicated in one higher layer parameter. In some embodiments, the fifth parameter for codebook and the sixth parameter for codebook may be configured or indicated in one higher layer parameter.

In some embodiments, the first parameter for codebook may be same with the fourth parameter for codebook. In some embodiments, the second parameter for codebook may be same with the fifth parameter for codebook. In some embodiments, the third parameter for codebook may be same with the sixth parameter for codebook.

In some embodiments, the second parameter for codebook may be at least one of {½, ¼, ⅛}. In some embodiments, the third parameter for codebook may be at least one of {¼, ½, ¾}. In some embodiments, the number of the plurality of first vectors (e.g. represented as L) may be at least one of {2, 4, 6} or at least one of {2, 4, 6, 8, 12, 16, 24, 32}. In some embodiments, L may be a positive integer. In some embodiments, L may be at least one of {2, 4, 6} or at least one of {2, 4, 6, 8, 12, 16, 24, 32}. In some embodiments, the number of the plurality of second vectors (e.g. represented as Lₜ) may be at least one of {2, 4, 6} or at least one of {2, 4, 6, 8}. In some embodiments, Lₜ may be a positive integer. In some embodiments, Lₜ may be at least one of {2, 4, 6}.

In some embodiments, the third parameter for codebook may further be based on number of layers. In some embodiments, one higher layer parameter may indicate L=2 and β=¼, and if number of layers is 1 or 2, pᵥ=¼, and if number of layers is 3 or 4, pᵥ=⅛. In some embodiments, one higher layer parameter may indicate L=2 and β=½, and if number of layers is 1 or 2, pᵥ=¼, and if number of layers is 3 or 4, pᵥ=⅛. In some embodiments, one higher layer parameter may indicate L=4 and β=¼, and if number of layers is 1 or 2, pᵥ=¼, and if number of layers is 3 or 4, pᵥ=⅛. In some embodiments, one higher layer parameter may indicate L=4 and β=½, and if number of layers is 1 or 2, pᵥ=¼, and if number of layers is 3 or 4, pᵥ=⅛. In some embodiments, one higher layer parameter may indicate L=4 and β=¾, and pᵥ=¼. In some embodiments, one higher layer parameter may indicate L=4 and β=½, and if number of layers is 1 or 2, pᵥ=½, and if number of layers is 3 or 4, pᵥ=¼. In some embodiments, one higher layer parameter may indicate L=6 and β=½, and pᵥ=¼. For example, the number of layers is 1 or 2. In some embodiments, one higher layer parameter may indicate L=6 and β=¾, and pᵥ=¼. For example, the number of layers is 1 or 2.

In some embodiments, one higher layer parameter may indicate Lₜ=2 and β=¼, and if number of layers is 1 or 2, pᵥ=¼, and if number of layers is 3 or 4, pᵥ=⅛. In some embodiments, one higher layer parameter may indicate Lₜ=2 and β=½, and if number of layers is 1 or 2, pᵥ=¼, and if number of layers is 3 or 4, pᵥ=⅛. In some embodiments, one higher layer parameter may indicate Lₜ=4 and β=¼, and if number of layers is 1 or 2, pᵥ=¼, and if number of layers is 3 or 4, pᵥ=⅛. In some embodiments, one higher layer parameter may indicate Lₜ=4 and β=½, and if number of layers is 1 or 2, pᵥ=¼, and if number of layers is 3 or 4, pᵥ=⅛. In some embodiments, one higher layer parameter may indicate Lₜ=4 and β=¾, and pᵥ=¼. In some embodiments, one higher layer parameter may indicate Lₜ=4 and β=½, and if number of layers is 1 or 2, pᵥ=½, and if number of layers is 3 or 4, pᵥ=¼. In some embodiments, one higher layer parameter may indicate Lₜ=6 and β=½, and pᵥ=¼. For example, the number of layers is 1 or 2. In some embodiments, one higher layer parameter may indicate Lₜ=6 and β=¾, and pᵥ=¼. For example, the number of layers is 1 or 2.

In some embodiments, the number of the plurality of first vectors may be based on the number of the plurality of second vectors and either one of the number of the first plurality of antenna port groups or the number of the second plurality of antenna port groups. In some embodiments, L=Lₜ*T₁. In some embodiments, L=Lₜ*Tₛ.

In some embodiments, the first parameter for codebook (For example, represented as R) may be a positive integer. For example, R may be a positive integer. For example, R may be at least one of {1, 2}. In some embodiments, a number of precoding matrices may be determined based on the first parameter for codebook, the number of the plurality of first subbands. In some embodiments, the first parameter for codebook may control the total number of precoding matrices indicated by the PMI as a function of the number of configured first subbands or the number of the plurality of first subbands, the size of one first subband and of the number of PRBs for the BWP.

In some embodiments, second subband may correspond to a subband for precoding matrix indicator (PMI) or PMI subband.

In some embodiments, the size of one second subband or the number of PRBs of one second subband may be represented as N_{PMI}, and N_{PMI} is a positive integer. For example, 1≤N_{PMI}≤32. For example, N_{PMI} may be at least one of {2, 4, 8, 16, 32}. In some embodiments, N_{PMI} may be based on N_{PRB}^{SB} and R. For example, N_{PMI}=N_{PRB}^{SB}/R.

In some embodiments, the number of the plurality of second subbands N₃ or the size or the length of one third vector may be a positive integer. For example, 9≤N₃≤36. For example, N₃=R*┌N_{BWP}^{size}/N_{PRB}^{SB}┐. For another example, N₃=R*└N_{BWP}^{size}/N_{PRB}^{SB}┘. For another example, N₃=R*┌N_{BWP}^{size}/N_{PRB}^{SB}┐. For another example, N₃=R*└N_{BWP}^{size}/P_{RBN}^{SB}┘+1. For another example, N₃=R*└N_{BWP}^{size}/N_{PRB}^{SB}┘+2. For another example, N₃=R*└N_{BWP}^{size}/N_{BWP}^{size}/N_{PRB}^{SB}┘+3. For another example, N₃=R*└N_{BWP}^{size}/N_{PRB}^{SB}┘+4.

In some embodiments, when R=1, there may be one precoding matrix indicated for each first subband. In some embodiments, when R=2, for one first subband that is not the first/beginning one or the last/ending one of the plurality of first subbands in the BWP, there may be two precoding matrixes indicated for the one of the plurality of first subbands. For example, the first precoding matrix corresponds to the first N_{PRB}^{SB}/2 PRBs of the one of the plurality of first subbands, and the second precoding matrix corresponds to the last N_{PRB}^{SB}/2 PRBs of the one of the plurality of first subbands. In some embodiments, when R=2, for one first subband that is the first/beginning one or the last/ending one of the plurality of first subbands in the BWP, if

$$( {N}_{BWP}^{start} mod {N}_{PRB}^{SB} ) \geq \frac{{N}_{PRB}^{SB}}{2} ,$$

there may be one precoding matrix indicated corresponding to the first/beginning one of the plurality of first subbands. In some embodiments, when R=2, for one first subband that is the first/beginning one or the last/ending one of the plurality of first subbands in the BWP, if

$$( {N}_{BWP}^{start} mod {N}_{PRB}^{SB} ) < \frac{{N}_{PRB}^{SB}}{2} ,$$

there may be two precoding matrices indicated corresponding to the first/beginning one of the plurality of first subbands. For example, the first precoding matrix may correspond to the first

$$\frac{{N}_{PRB}^{SB}}{2} - ( {N}_{BWP}^{start} mod {N}_{PRB}^{SB} )$$

PRBs of the first/beginning one of the plurality of first subbands and the second precoding matrix corresponds to the last

$$\frac{{N}_{PRB}^{SB}}{2}$$

PRBs of the first/beginning one of the plurality of first subbands. In some embodiments, when R=2, for one first subband that is the first/beginning one or the last/ending one of the plurality of first subbands in the BWP, if

$$1 + ( {N}_{BWP}^{start} + {N}_{BWP}^{size} - 1 ) mod {N}_{PRB}^{SB} \leq \frac{{N}_{PRB}^{SB}}{2} ,$$

there may be one precoding matrix indicated corresponding to the last/ending one of the plurality of first subbands. In some embodiments, when R=2, for one first subband that is the first/beginning one or the last/ending one of the plurality of first subbands, if

$$1 + ( {N}_{BWP}^{start} + {N}_{BWP}^{size} - 1 ) mod {N}_{PRB}^{SB} > \frac{{N}_{PRB}^{SB}}{2} ,$$

there may be two precoding matrices indicated corresponding to the last/ending one of the plurality of first subbands. For example, the first precoding matrix may correspond to the first

$$\frac{{N}_{PRB}^{SB}}{2}$$

PRBs of the last/ending one of the plurality of first subbands and the second precoding matrix may correspond to the last

$$1 + ( {N}_{BWP , i}^{start} + {N}_{BWP , i}^{size} - 1 ) mod {N}_{PRB}^{SB} - \frac{{N}_{PRB}^{SB}}{2}$$

PRBs of the last/ending one of the plurality of first subbands.

In some embodiments, the number of the plurality of third vectors Mᵥ may be a positive integer. For example,

$${M}_{v} = ⌈ {p}_{v} \frac{{N}_{3}}{R} ⌉ .$$

For example, Mᵥ may be at least one of {1, 2, 3, 4, 5, 6, 7, 8, 9, 10}.

In some embodiments, the value of the first parameter R for codebook may be determined based on the number of second plurality of antenna port groups (or based on value of Tₛ). In some embodiments, if the number of second plurality of antenna port groups is 1 or Tₛ=1, the value of the first parameter R may be at least one of {1, 2}. In some embodiments, if the number of the second plurality of antenna port groups is larger than 1 or Tₛ>1 (for example, Tₛ=2 or 3 or 4, the value of the first parameter R may be at least one of {2, 4} or {2, 3} or {1, 3} or {1, 4} or {1, 2, 3, 4} or {3, 4}. In some embodiments, if the number of the second plurality of antenna port groups is 4 (for example, Tₛ=4, the value of the first parameter R may be at least one of {2, 4} or {3,4}.

In some embodiments, a plurality of precoding matrices may be determined from L+Mᵥ vectors or Lₜ+Mᵥ vectors or T·Lₜ+Mᵥ vectors or Tₛ·Lₜ+Mᵥ vectors or L+Mᵥ+M_{w} vectors or Lₜ+Mᵥ+M_{w} vectors or T·Lₜ+Mᵥ+M_{w} vectors or Tₛ·Lₜ+Mᵥ+M_{w} vectors.

In some embodiments, the bit size of the one or more indicators (or the field) for the second plurality of antenna port groups may be ceil(log 2(nchoosek(T₁, Tₛ))). In some embodiments, the bit size of the one or more indicators (or the field) for the second plurality of antenna port groups may be ceil(log 2(T₁!/(T₁−Tₛ)!)).

In some embodiments, nchoosek may be a function to choose k values from n values. In some embodiments, nchoosek(a,b)=a!/(b!*(a−b)!). In some embodiments, “!” may be factorial. In some embodiments, a!=1*2* . . . *(a−1)*a.

In some embodiments, the at least one codebook indicator may be comprised in a PMI. In some embodiments, the PMI may comprise a first part of the PMI and a second part of the PMI. For example, the size of the second part of the PMI may be based on the first part of the PMI. In some embodiments, the PMI may comprise a first part of the PMI, a second part of the PMI and a third part of the PMI. For example, the size of the second part of the PMI may be based on the first part of the PMI. For another example, the size of the third part of the PMI may be based on at least one of the first part of the PMI and the second part of the PMI.

In some embodiments, the one or more indicators (or the field) for the second plurality of antenna port groups may be comprised in the PMI or in the first part of the PMI.

In some embodiments, a number of the one or more indicators (or one or more indexes or one or more fields) for a first antenna port group may be same as the number of layers. In some embodiments, the number of the one or more indicators (or one or more indexes or one or more fields) for a first antenna port group may be 1. For example, common for each layer of the number of layers. In some embodiments, the one or more indicators (or one or more indexes or one or more fields) for a first antenna port group may be same for each layer of the number of layers.

In some embodiments, the index of the first antenna port group may be Tₘ. For example, Tₘ may be a non-negative integer. For example, 1≤Tₘ≤T₁. For another example, 0≤Tₘ≤T₁−1. For another example, 1≤Tₘ≤Tₛ. For another example, 0≤Tₘ≤Tₛ−1.

In some embodiments, the bit size for the one or more indicators (or one or more indexes or one or more fields) for the first antenna port group may be based on the number of the first plurality of antenna port groups. In some embodiments, the bit size for the one or more indicators (or one or more indexes or one or more fields) for the first antenna port group may be ceil(log 2(T₁)). In some embodiments, the bit size for the one or more indicators (or one or more indexes or one or more fields) for the first antenna port group may be ceil(log 2(Tₛ). In some embodiments, the one or more indicators (or one or more indexes or one or more fields) for the first antenna port group may be comprised in the PMI or in the first part of the PMI or in the second part of the PMI.

In some embodiments, the one or more indicators (or the field) for the second plurality of antenna port groups may indicate an order of the second plurality of antenna port groups. In some embodiments, the first one of the indicated second plurality of antenna port groups may be same as the index (or indicator) of the first antenna port group.

In some embodiments, one second vector of the plurality of second vectors may be represented as vₗ_{ₜ}_{⁽ⁱ⁾}_{,m}_{ₜ}_{⁽ⁱ⁾}. In some embodiments,

$${v}_{{l}_{t}^{( i )} , {m}_{t}^{( i )}} = {[ {u}_{{m}_{t}^{( i )}} , {u}_{{m}_{t}^{( i )}} * {e}^{j \frac{2 π {l}_{t}^{( i )}}{{O}_{1} {N}_{1}}} , ... , {u}_{{m}_{t}^{( i )}} * {e}^{j \frac{2 π {l}_{t}^{( i )} * ( {N}_{1} - 1 )}{{O}_{1} {N}_{1}}} ]}^{T} .$$

In some embodiments,

$${u}_{{m}_{t}^{( i )}} = \{ \begin{matrix}[ 1 , {e}^{j \frac{2 π {m}_{t}^{( i )}}{{O}_{2} {N}_{2}}} , ... , {e}^{j \frac{2 π {m}_{t}^{( i )} ( {N}_{2} - 1 )}{{O}_{2} {N}_{2}}} ] & {N}_{2} > 1 \\ 1 & {N}_{2} = 1\end{matrix} .$$

In some embodiments, lₜ⁽ⁱ⁾∈{0, 1, . . . O₁N₁−1}. In some embodiments, mₜ⁽ⁱ⁾∈{0, 1, . . . O₂N₂−1}. In some embodiments, lₜ⁽ⁱ⁾=O₁n_{1,t}⁽ⁱ⁾+q_{1,t}, mₜ⁽ⁱ⁾=O₂n_{2,t}⁽ⁱ⁾+q_{2,t}. In some embodiments, i=0, 1, . . . . Lₜ−1. In some embodiments, t=0, 1, . . . . T₁−1. In some embodiments, t=0, 1, . . . . Tₛ−1.

In some embodiments, q_{1,t} and q_{2,t} may be rotations of the second plurality of rotations for the plurality of second vectors. For example, the q_{1,t} and q_{2,t} may be the rotations corresponding to antenna port group with index t. In some embodiments, q_{1,t}∈{0, 1, . . . O₁−1}. In some embodiments, q_{2,t}∈{0, 1, . . . O₂−1}.

In some embodiments, the length of one first vector may be based on the number of the second plurality of antenna port groups. In some embodiments, the length of one first vector may be the number of the plurality of antenna ports in one antenna port group multiplies the number of the second plurality of antenna port groups and divided by 2 or based on the fifth value. In some embodiments, the length of one first vector may be P*Tₛ or P*T₁/2 or Pₜ*Tₛ/2 or Pₜ*T₁/2.

In some embodiments, the length of one second vector may be based on the number of antenna ports in one antenna port group. In some embodiments, the length of one second vector may be P/2 or Pₜ/2.

In some embodiments, the number of the plurality of first vectors may be based on the number of the plurality of second vectors and either one of the number of the first plurality of antenna port groups or the number of the second plurality of antenna port groups.

In some embodiments, the length of one first vector may be based on the number of antenna ports in one antenna port group and at least one of: the number of the first plurality of antenna port groups; the number of the second plurality of antenna port groups; and values of the plurality of first amplitude coefficients.

In some embodiments, one first vector may be determined based on the plurality of second vectors and at least one of the plurality of first amplitude coefficients and the plurality of first phase coefficients.

In some embodiments, the number of the plurality of first vectors may be same as the number of plurality of second vectors.

In some embodiments, the number of the plurality of first vectors may be based on the number of the first plurality of antenna port groups and the number of the plurality of second vectors. In some embodiments, the number of the plurality of first vectors may be based on the number of the second plurality of antenna port groups and the number of the plurality of second vectors.

In some embodiments, the number of indicators (or the fields) for the strongest coefficient may be based on the number of layers, and each one indicator (or the field) for the strongest coefficient corresponds to a layer with an index.

In some embodiments, the indicator (or the field) for the strongest coefficient corresponds to a layer with an index or the bit size (or bitwidth) of indicator (or the field) for the strongest coefficient corresponds to a layer with an index may be based on at least one of: a value of 2; the first number of nonzero coefficients corresponding to one layer with an index; the number of the first plurality of first vectors; the number of the second plurality of antenna port groups and the number of the plurality of second vectors, index (or indicator) of the first antenna port group. In some embodiments, the bit size of the index or indicator of the first antenna port group may be based on the number of the first plurality of antenna port groups; and the number of the plurality of second vectors.

In some embodiments, the bit size of the indicator (or the field) for the strongest coefficient corresponds to a layer with an index may be based on at least one of: the first number of nonzero coefficients corresponding to one layer with an index; 2 multiplies the number of the first plurality of first vectors; 2 multiplies the number of the second plurality of antenna port groups and multiplies the number of the second plurality of second vectors; and 2 multiples the number of the plurality of second vectors.

In some embodiments, the indicator (or the field) for the strongest coefficient corresponds to a layer with an index may be comprised in the PMI or in the first part of the PMI or in the second part of the PMI.

In some embodiments, the number of one or more indicators (or the field) for the plurality of first amplitude coefficients may be based on the number of the first plurality of antenna port groups or the number of the second plurality of antenna port groups. In some embodiments, the number of one or more indicators (or the field) for the plurality of first amplitude coefficients may be based on the number of the first plurality of antenna port groups minus 1 or the number of the second plurality of antenna port groups minus 1.

In some embodiments, the number of one or more indicators (or the field) for the plurality of first amplitude coefficients may be K_{b1}*(T−1) or K_{b1}*(T₁−1) or K_{b1}*(Tₛ−1) or K_{b1}*Σ_{t=0, and t≠T}_{ₘ}^{T-1}N_{g,t}. In some embodiments, K_{b1} may be the bit size for each of the first amplitude coefficients. For example, K_{b1} may be 2 or 3 or 4 bits.

In some embodiments, the number of one or more indicators (or the field) for the plurality of first amplitude coefficients may be based on the number of the plurality of fourth vectors and either one of: the number of the first plurality of antenna port groups; or the number of the second plurality of antenna port groups.

In some embodiments, the number of one or more indicators (or the field) for the plurality of first amplitude coefficients may be K_{b1}*(T−1)*M_{w} or K_{b1}*(T₁−1)*M_{w} or K_{b1}*(Tₛ−1)*M_{w} or K_{b1}*M_{w}*Σ_{t=0, and t≠T}_{ₘ}^{T-1}N_{g,t}.

In some embodiments, the one or more indicators (or the field) for the plurality of first amplitude coefficients may be comprised in the PMI or in the first part of the PMI or in the second part of the PMI.

In some embodiments, the number of one or more indicators (or the field) for the plurality of first phase coefficients may be based on the number of the first plurality of antenna port groups or the number of the second plurality of antenna port groups. In some embodiments, the number of one or more indicators (or the field) for the plurality of first phase coefficients may be based on the number of the first plurality of antenna port groups minus 1 or the number of the second plurality of antenna port groups minus 1.

In some embodiments, the number of one or more indicators (or the field) for the plurality of first phase coefficients may be K_{b2}*(T−1) or K_{b2}*(T₁−1) or K_{b2}*(Tₛ−1) or K_{b2}*Σ_{t=0, and t≠T}_{ₘ}^{T-1}N_{g,t}. In some embodiments, K_{b2} may be the bit size for each of the first phase coefficients. For example, K_{b2} may be 2 or 3 or 4 bits.

In some embodiments, the number of one or more indicators (or the field) for the plurality of first phase coefficients may be based on the number of the plurality of fourth vectors and either one of: the number of the first plurality of antenna port groups; or the number of the second plurality of antenna port groups.

In some embodiments, the number of one or more indicators (or the field) for the plurality of first phase coefficients may be K_{b2}*(T−1)*M_{w} or K_{b2}*(T₁−1)*M_{w} or K_{b2}*(Tₛ−1)*M_{w} or K_{b2}*M_{w}*Σ_{t=0, and t≠T}_{ₘ}^{T-1}N_{g,t}.

In some embodiments, the one or more indicators (or the field) for the plurality of first phase coefficients may be comprised in the PMI or in the first part of the PMI or in the second part of the PMI.

In some embodiments, the indicator of the first amplitude coefficient for the first antenna port group may be fixed. For example, the indicator of the first amplitude coefficient for the first antenna port group may be fixed as 0 or 7 or 15 or 3. In some embodiments, the value of the first amplitude coefficient for the first antenna port group may be fixed. In some embodiments, the value of the first amplitude coefficient for the first antenna port group may be fixed as 1.

In some embodiments, the indicator of the first phase coefficient for the first antenna port group may be fixed. For example, the indicator of the first phase coefficient for the first antenna port group may be fixed as 0 or 7 or 15 or 3. In some embodiments, the value of the first phase coefficient for the first antenna port group may be fixed. In some embodiments, the value of the first phase coefficient for the first antenna port group may be fixed as 1 or e^{j2π*0}.

In some embodiments, the number of one or more indicators (or the field) for the plurality of second amplitude coefficients may be based on at least one of: the number of the second plurality of antenna port groups and the value of the first amplitude coefficient for an antenna port group.

In some embodiments, the one or more indicators (or the field) for the plurality of second amplitude coefficients may be comprised in the PMI or in the first part of the PMI or in the second part of the PMI.

In some embodiments, values of one second amplitude coefficient may be larger than 0 or not 0.

In some embodiments, the one or more indicators (or one or more bitmaps) for indicating nonzero coefficients may indicate indexes of third amplitude coefficients and/or indexes of third phase coefficients. In some embodiments, each bit or codepoint of the indicator (or bitmap) may indicate whether the third amplitude coefficient and/or the third phase coefficient corresponding to a layer with an index, corresponding to a first vector (or a first beam) with an index and corresponding to a third vector with an index is reported or not (or the value is 0 or not). In some embodiments, a value of each bit is either 0 or 1. For example, 0 may indicate the third amplitude coefficient and/or the third phase coefficient corresponding to the layer with an index, corresponding to a first vector (or a first beam) with the index and corresponding to the third vector with an index is not reported (or the value is 0). For example, 1 may indicate the third amplitude coefficient and/or the third phase coefficient corresponding to the layer with an index, corresponding to a first vector (or a first beam) with the index and corresponding to the third vector with an index is reported (or the value is not 0).

In some embodiments, the number of the one or more indicators (or one or more bitmaps) for indicating nonzero coefficients may be same as the number of layers. For example, each one indicator (or one bitmap) for indicating nonzero coefficients may correspond to one layer with an index.

In some embodiments, the size of the indicator (or the bitmap) for indicating nonzero coefficients corresponding to the layer with an index may be based on the number of the plurality of third vectors corresponding to the layer with an index and either one of: the number of the plurality of first vectors; the number of the plurality of second vectors and the number of second plurality of antenna port groups; or the number of the plurality of second vectors.

In some embodiments, the number of the plurality of third vectors may be determined based on at least one of: the number of layers; the size of one first subband; the first parameter for codebook; the size of one second subband; the third parameter for codebook; and the second parameter for codebook.

In some embodiments, if the first amplitude coefficient for antenna port group with index t is 0, the values of bits (or codepoints) of the indicator (or the bitmap) for indicating nonzero coefficients corresponding to the layer with an index, corresponding to the plurality of second vectors corresponding to the antenna port group with index t and corresponding to the plurality of third vectors may be 0.

In some embodiments, if the first amplitude coefficient for antenna port group with index tis 0, the indicator (or bitmap) for indicating nonzero coefficients corresponding to the antenna port group with index t may not be reported.

In some embodiments, a number of the one or more indicators (or the one or more bitmaps) for indicating nonzero coefficients may be based on the number of layers and either one of: the number of the first plurality of antenna port groups; or the number of the second plurality of antenna port groups. In some embodiments, each one of the one or more indicators (or the one or more bitmaps) for indicating nonzero coefficients may correspond to a layer with an index. In some embodiments, each one of the one or more indicators (or the one or more bitmaps) for indicating nonzero coefficients may correspond to one of the first or the second plurality of antenna port groups.

In some embodiments, the first number of nonzero coefficients corresponding to a layer with an index may be based on a second number of nonzero coefficients corresponding to an antenna port group with index t and either one of: the number of the first plurality of antenna port groups or the number of the second plurality of antenna port groups.

In some embodiments, the number of one or more indicators (or the field) for the plurality of third amplitude coefficients corresponding to a layer with an index may be based on at least one of: the first number of nonzero coefficients; a number of values (or bits or codepoints) with value “1” or a number of ones in the indicator (or bitmap) for indicating nonzero coefficients corresponding to the layer with the index; the number of the second plurality of antenna port groups; and one or more values of the first amplitude coefficient for an antenna port group with index t.

In some embodiments, the one or more indicators (or the field) for the plurality of third amplitude coefficients may be comprised in the PMI or in the second part of the PMI or in the third part of the PMI. In some embodiments, for each antenna port group with index t, there may be one field for the plurality of third amplitude coefficients corresponding to one layer with an index.

In some embodiments, any one of possible values for one third amplitude coefficient may be larger than 0 or may not be 0.

In some embodiments, the number of one or more indicators (or the field) for the plurality of third amplitude coefficients corresponding to a layer with an index may be based on at least one of: the first number of nonzero coefficients; a number of values (or bits or codepoints) with value “1” or a number of ones in the indicator (or bitmap) for indicating nonzero coefficients corresponding to the layer with the index; the number of the second plurality of antenna port groups; and one or more values of the first amplitude coefficient for an antenna port group with index t.

In some embodiments, the antenna port group with index t may be comprised or indicated in the second plurality of antenna port groups.

In some embodiments, the number of one or more indicators (or the field) for the plurality of third phase coefficients corresponding to a layer with an index may be based on at least one of: the first number of nonzero coefficients; a number of values (or bits or codepoints) with value “1” or a number of ones in the indicator (or bitmap) for indicating nonzero coefficients corresponding to the layer with the index; the number of the second plurality of antenna port groups; and one or more values of the first amplitude coefficient for an antenna port group with index t.

In some embodiments, the one or more indicators (or the field) for the plurality of third phase coefficients may be comprised in the PMI or in the second part of the PMI or in the third part of the PMI. In some embodiments, for each antenna port group with index t, there may be one field for the plurality of phase amplitude coefficients corresponding to one layer with an index.

In some embodiments, the number of one or more indicators (or the field) for the plurality of third phase coefficients corresponding to a layer with an index may be based on at least one of: the first number of nonzero coefficients; a number of values (or bits or codepoints) with value “1” or a number of ones in the indicator (or bitmap) for indicating nonzero coefficients corresponding to the layer with the index; the number of the second plurality of antenna port groups; and one or more values of the first amplitude coefficient for an antenna port group with index t.

In some embodiments, the antenna port group with index t may be comprised or indicated in the second plurality of antenna port groups.

In some embodiments, the number of the plurality of third vectors Mᵥ may be determined based on at least one of: the number of PRBs for the BWP; the number of layers; the size of one first subband; the number of the plurality of first subbands; the first parameter for codebook the size of one second subband; the number of the plurality of second subbands; and the second parameter for codebook. In some embodiments, the second parameter for codebook may be determined based on the number of layers.

In some embodiments, a size or a length of one third vector may be determined based on at least one of: the number of PRBs for the BWP; the number of layers; the size of one first subband; the number of the plurality of first subbands; the first parameter for codebook; the size of one second subband; the number of the plurality of second subbands; and the second parameter for codebook. In some embodiments, the size or the length of one third vector may be N₃.

In some embodiments, the number of the plurality of fourth vectors M_{w} may be determined based on at least one of: the number of PRBs for the BWP; the number of layers; the size of one first subband; the number of the plurality of first subbands; the first parameter for codebook; the size of one second subband; the number of the plurality of second subbands; the second parameter for codebook; the size of one third subband; the fourth parameter for codebook; the fifth parameter for codebook and the sixth parameter for codebook. In some embodiments, the size of one third subband may be determined based on at least one of: the size of one first subband and the first parameter for codebook; the size of one first subband and the fourth parameter for codebook; and the size of one second subband and the fourth parameter for codebook.

In some embodiments, the number of the plurality of fourth vectors M_{w} may be a positive integer. For example,

$${M}_{w} = ⌈ {p}_{v} \frac{{N}_{3}}{R} ⌉ .$$

For another example,

$${M}_{w} = ⌈ {p}_{v , w} \frac{{N}_{3}}{{R}_{w}} ⌉ .$$

For another example,

$${M}_{w} = ⌈ {p}_{v , w} \frac{{N}_{4}}{{R}_{w}} ⌉ .$$

For example, M_{w} may be at least one of {1, 2, 3, 4, 5, 6, 7, 8, 9, 10}.

In some embodiments, a size or a length of one fourth vector may be determined based on at least one of: the number of PRBs for the BWP; the number of layers; the size of one first subband; the number of the plurality of first subbands; the first parameter for codebook; the size of one second subband; the number of the plurality of second subbands; the second parameter for codebook; the size of one third subband and the fourth parameter for codebook. In some embodiments, the size or the length of one fourth vector may be N₄.

In some embodiments, the fourth parameter for codebook R_{w} may be at least one of {⅛, ¼, ½, 1, 2}.

In some embodiments, the number of the plurality of third subbands N₃ or the size or the length of one fourth vector may be a positive integer. For example, 1≤N₄≤36. For example, N₄=┌R_{w}*N_{BWP}^{size}/N_{PRB}^{SB}┐. For another example, N₃=┌R_{w}*└N_{BWP}^{size}/N_{PRB}^{SB}┘┐.

In some embodiments, the one or more indicators (or a field) for a plurality of second phase coefficients may be comprised in the PMI or in the first part of the PMI or in the second part of the PMI.

In some embodiments, the terminal device may receive a CSI-RS, wherein the number of antenna ports for the CSI-RS may be determined based on the at least one parameter for antenna ports. In some embodiments, the number of antenna ports for the CSI-RS may be the number of the first plurality of antenna port groups multiplies the number of antenna ports in one antenna port group.

In some embodiments, for each one of the second plurality of antenna port groups, one or more indicators for the plurality of third amplitude coefficients and/or one or more indicators for the plurality of third phase coefficients may be reported or included or comprised in the PMI or in the second part of the PMI or in the third part of the PMI.

In some embodiments, one first vector may be determined based on one or more second vectors and at least one of: one or more first amplitude coefficients, and one or more first phase coefficients. In some embodiments, the one first vector may be further determined based on the number of first plurality of antenna port groups or the number of second plurality of antenna port groups.

In some embodiments, one first vector may be represented as vᵢ,

$${v}_{i} = [ \begin{matrix}{v}_{{l}_{0}^{( i )} , {m}_{0}^{( i )}} * {P}_{0}^{( 0 )} * {φ}_{0}^{( 0 )} \\ {v}_{{l}_{1}^{( i )} , {m}_{1}^{( i )}} * {P}_{1}^{( 0 )} * {φ}_{1}^{( 0 )} \\ ⋮ \\ {v}_{{l}_{T - 1}^{( i )} , {m}_{T - 1}^{( i )}} * {P}_{T - 1}^{( 0 )} * {φ}_{T - 1}^{( 0 )}\end{matrix} ]$$

In some embodiments, Pₜ⁽⁰⁾ may be a first amplitude coefficient for antenna port group with index t. In some embodiments, φₜ⁽⁰⁾ may be a first phase coefficient for antenna port group with index t.

In some embodiments, T may be based on the number of first plurality of antenna port groups T₁. In some embodiments, T=T₁. In some embodiments, T may be based on the number of second plurality of antenna port groups Tₛ. In some embodiments, T=Tₛ.

In some embodiments,

$${W}_{1} = [ \begin{matrix}B & 0 \\ 0 & B\end{matrix} ] ,$$

wherein B=v₀v₁ . . . v_{L}_{ₜ}₋₁. For example, size of W₁ may be (2*N₁*N₂*T)*(2*Lₜ) or (2*N₁*N₂*Tₛ)*(2*Lₜ). For example, a size of each element in W₁ may be (N₁*N₂*T)*Lₜ, “0” in W₁ may be a zero matrix with size (N₁*N₂*T)*Lₜ.

In some embodiments,

$${W}_{1} = [ \begin{matrix}{v}_{0} {v}_{1} … {v}_{{L}_{t} - 1} & 0 \\ 0 & {v}_{0} {v}_{1} … {v}_{{L}_{t} - 1}\end{matrix} ] .$$

In some embodiments, W₁=W₀₁*W₀₂.

In some embodiments,

$${W}_{01} = [ \begin{matrix}{B}^{( 0 )} & 0 & 0 & 0 & 0 & 0 & 0 & 0 \\ 0 & {B}^{( 1 )} & 0 & 0 & 0 & 0 & 0 & 0 \\ 0 & 0 & ⋱ & 0 & 0 & 0 & 0 & 0 \\ 0 & 0 & 0 & {B}^{( T - 1 )} & 0 & 0 & 0 & 0 \\ 0 & 0 & 0 & 0 & {B}^{( 0 )} & 0 & 0 & 0 \\ 0 & 0 & 0 & 0 & 0 & {B}^{( 1 )} & 0 & 0 \\ 0 & 0 & 0 & 0 & 0 & 0 & ⋱ & 0 \\ 0 & 0 & 0 & 0 & 0 & 0 & 0 & {B}^{( T - 1 )}\end{matrix} ] ,$$

In some embodiments,

$${W}_{01} = [ \begin{matrix}{σ}_{0} ( 0 ) * {B}^{( 0 )} & {σ}_{0} ( 0 ) * {B}^{( 1 )} & & {σ}_{0} ( T - 1 ) * {B}^{( T - 1 )} & 0 & 0 & & 0 \\ {σ}_{1} ( 0 ) * {B}^{( 0 )} & {σ}_{1} ( 1 ) * {B}^{( 1 )} & & {σ}_{1} ( T - 1 ) * {B}^{( T - 1 )} & 0 & 0 & & 0 \\ ⋮ & ⋮ & & ⋮ & 0 & 0 & & 0 \\ {σ}_{T - 1} ( 0 ) * {B}^{( 0 )} & {σ}_{T - 1} ( 1 ) * {B}^{( 1 )} & … & {σ}_{T - 1} ( T - 1 ) * {B}^{( T - 1 )} & 0 & 0 & & 0 \\ 0 & 0 & & 0 & {σ}_{0} ( 0 ) * {B}^{( 0 )} & {σ}_{0} ( 0 ) * {B}^{( 1 )} & … & {σ}_{0} ( T - 1 ) * {B}^{( T - 1 )} \\ 0 & 0 & & 0 & {σ}_{1} ( 0 ) * {B}^{( 0 )} & {σ}_{1} ( 1 ) * {B}^{( 1 )} & & {σ}_{1} ( T - 1 ) * {B}^{( T - 1 )} \\ 0 & 0 & & 0 & ⋮ & ⋮ & & ⋮ \\ 0 & 0 & & 0 & {σ}_{T - 1} ( 0 ) * {B}^{( 0 )} & {σ}_{T - 1} ( 1 ) * {B}^{( 1 )} & & {σ}_{T - 1} ( T - 1 ) * {B}^{( T - 1 )}\end{matrix} ]$$

In some embodiments, if the number of the first plurality of antenna port groups is 2 or if the number of the second plurality of antenna port groups is 2 (for example, T=2),

$${W}_{01} = [ \begin{matrix}{B}^{( 0 )} & {B}^{( 1 )} & 0 & 0 \\ {B}^{( 0 )} & - {B}^{( 1 )} & 0 & 0 \\ 0 & 0 & {B}^{( 0 )} & {B}^{( 1 )} \\ 0 & 0 & {B}^{( 0 )} & - {B}^{( 1 )}\end{matrix} ] .$$

In some embodiments, if the number of the first plurality of antenna port groups is 4 or if the number of the second plurality of antenna port groups is 4 (for example, T=4),

$${W}_{01} = [ \begin{matrix}{B}^{( 0 )} & {B}^{( 1 )} & {B}^{( 2 )} & {B}^{( 3 )} & 0 & 0 & 0 & 0 \\ {B}^{( 0 )} & - {B}^{( 1 )} & {B}^{( 2 )} & - {B}^{( 3 )} & 0 & 0 & 0 & 0 \\ {B}^{( 0 )} & {B}^{( 1 )} & - {B}^{( 2 )} & - {B}^{( 3 )} & 0 & 0 & 0 & 0 \\ {B}^{( 0 )} & - {B}^{( 1 )} & - {B}^{( 2 )} & {B}^{( 3 )} & 0 & 0 & 0 & 0 \\ 0 & 0 & 0 & 0 & {B}^{( 0 )} & {B}^{( 1 )} & {B}^{( 2 )} & {B}^{( 3 )} \\ 0 & 0 & 0 & 0 & {B}^{( 0 )} & - {B}^{( 1 )} & {B}^{( 2 )} & - {B}^{( 3 )} \\ 0 & 0 & 0 & 0 & {B}^{( 0 )} & {B}^{( 1 )} & - {B}^{( 2 )} & - {B}^{( 3 )} \\ 0 & 0 & 0 & 0 & {B}^{( 0 )} & - {B}^{( 1 )} & - {B}^{( 2 )} & {B}^{( 3 )}\end{matrix} ]$$

In some embodiments, first vector may be

$${v}_{i} = [ \begin{matrix}{\sum }_{t = 0}^{T - 1} {σ}_{0} ( t ) * {v}_{{l}_{t}^{( i )} , {m}_{t}^{( i )}} * {P}_{t}^{( 0 )} * {φ}_{t}^{( 0 )} \\ {\sum }_{t = 0}^{T - 1} {σ}_{1} ( t ) * {v}_{{l}_{t}^{( i )} , {m}_{t}^{( i )}} * {P}_{t}^{( 0 )} * {φ}_{t}^{( 0 )} \\ ⋮ \\ {\sum }_{t = 0}^{T - 1} {σ}_{T - 1} ( t ) * {v}_{{l}_{t}^{( i )} , {m}_{t}^{( i )}} * {P}_{t}^{( 0 )} * {φ}_{t}^{( 0 )}\end{matrix} ] .$$

In some embodiments, if the number of the first plurality of antenna port groups is 2 or if the number of the second plurality of antenna port groups is 2 (for example, T=2), σ₀(t)=[1, 1], σ₁(t)=[1, −1].

In some embodiments, if the number of the first plurality of antenna port groups is 4 or if the number of the second plurality of antenna port groups is 4 (for example, T=4), σ₀(t)=[1,1,1,1], σ₁(t)=[1,−1,1,−1], σ₂(t)=[1,1,−1,−1], σ₃(t)=[1,−1,−1,1].

In some embodiments, the size of W₀₁ may be (2*N₁*N₂)*(2*Lₜ).

In some embodiments, B^{(t)}=[vₗ_{ₜ}_{⁽⁰⁾}_{,m}_{ₜ}_{⁽⁰⁾} vₗ_{ₜ}_{⁽¹⁾}_{,m}_{ₜ}_{⁽¹⁾} . . . vₗ_{ₜ}_{^{(Lt-1)}}_{,m}_{ₜ}_{^{(Lt-1)}}].

In some embodiments,

$${W}_{02} = [ \begin{matrix}{P}_{0}^{( 0 )} * {φ}_{0}^{( 0 )} \\ {P}_{1}^{( 0 )} * {φ}_{1}^{( 0 )} \\ ⋮ \\ {P}_{T - 1}^{( 0 )} * {φ}_{T - 1}^{( 0 )} \\ {P}_{0}^{( 0 )} * {φ}_{0}^{( 0 )} \\ {P}_{1}^{( 0 )} * {φ}_{1}^{( 0 )} \\ ⋮ \\ {P}_{T - 1}^{( 0 )} * {φ}_{T - 1}^{( 0 )}\end{matrix} ]$$

In some embodiments,

$${W}_{1} = [ \begin{matrix}B & 0 \\ 0 & B\end{matrix} ] = {W}_{01} * {W}_{02} = [ \begin{matrix}{B}^{( 0 )} & 0 & 0 & 0 & 0 & 0 & 0 & 0 \\ 0 & {B}^{( 1 )} & 0 & 0 & 0 & 0 & 0 & 0 \\ 0 & 0 & ⋱ & 0 & 0 & 0 & 0 & 0 \\ 0 & 0 & 0 & {B}^{( T - 1 )} & 0 & 0 & 0 & 0 \\ 0 & 0 & 0 & 0 & {B}^{( 0 )} & 0 & 0 & 0 \\ 0 & 0 & 0 & 0 & 0 & {B}^{( 1 )} & 0 & 0 \\ 0 & 0 & 0 & 0 & 0 & 0 & ⋱ & 0 \\ 0 & 0 & 0 & 0 & 0 & 0 & 0 & {B}^{( T - 1 )}\end{matrix} ] * [ \begin{matrix}{P}_{0}^{( 0 )} * {φ}_{0}^{( 0 )} \\ {P}_{1}^{( 0 )} * {φ}_{1}^{( 0 )} \\ ⋮ \\ {P}_{T - 1}^{( 0 )} * {φ}_{T - 1}^{( 0 )} \\ {P}_{0}^{( 0 )} * {φ}_{0}^{( 0 )} \\ {P}_{1}^{( 0 )} * {φ}_{1}^{( 0 )} \\ ⋮ \\ {P}_{T - 1}^{( 0 )} * {φ}_{T - 1}^{( 0 )}\end{matrix} ]$$

In some embodiments, for W₂ corresponding to layer with index r:

$${\overline{W}}_{2} = [ \begin{matrix}\begin{matrix}{P}_{r , 0}^{( 1 )} * {P}_{r , 0 , 0 , 0}^{( 2 )} * \\ {φ}_{r , 0 , 0 , 0}^{( 2 )}\end{matrix} & \begin{matrix}{P}_{r , 0}^{( 1 )} * {P}_{r , 0 , 1}^{( 2 )} * \\ {φ}_{r , 0 , 0 , 1}^{( 2 )}\end{matrix} & & \begin{matrix}{P}_{r , 0}^{( 1 )} * {P}_{r , 0 , {M}_{v} - 1}^{( 2 )} * \\ {φ}_{r , 0 , 0 , {M}_{v} - 1}^{( 2 )}\end{matrix} \\ \begin{matrix}{P}_{r , 0}^{( 1 )} * {P}_{r , 1 , 0 , 0}^{( 2 )} * \\ {φ}_{r , 1 , 0 , 0}^{( 2 )}\end{matrix} & \begin{matrix}{P}_{r , 0}^{( 1 )} * {P}_{r , 1 , 0 , 1}^{( 2 )} * \\ {φ}_{r , 1 , 0 , 1}^{( 2 )}\end{matrix} & & \begin{matrix}{P}_{r , 0}^{( 1 )} * {P}_{r , 1 , 0 , {M}_{v} - 1}^{( 2 )} * \\ {φ}_{r , {L}_{t} - 1 , 0 , {M}_{v} - 1}^{( 2 )}\end{matrix} \\ ⋮ & ⋮ & & ⋮ \\ \begin{matrix}{P}_{r , 0}^{( 1 )} * {P}_{r , {L}_{t} - 1 , 0 , 0}^{( 2 )} * \\ {φ}_{r , {L}_{t} - 1 , 0 , 0}^{( 2 )}\end{matrix} & \begin{matrix}{P}_{r , 0}^{( 1 )} * {P}_{r , {L}_{t} - 1 , 0 , 1}^{( 2 )} * \\ {φ}_{r , {L}_{t} - 1 , 0 , 1}^{( 2 )}\end{matrix} & … & \begin{matrix}{P}_{r , 0}^{( 1 )} * {P}_{r , {L}_{t} - 1 , 0 , {M}_{v} - 1}^{( 2 )} * \\ {φ}_{r , {L}_{t} - 1 , 0 , {M}_{v} - 1}^{( 2 )}\end{matrix} \\ \begin{matrix}{P}_{r , 1}^{( 1 )} * {P}_{r , 0 , 1 , 0}^{( 2 )} * \\ {φ}_{r , 0 , 1 , 0}^{( 2 )}\end{matrix} & \begin{matrix}{P}_{r , 1}^{( 1 )} * {P}_{r , 0 , 1 , 1}^{( 2 )} * \\ {φ}_{r , 0 , 1 , 1}^{( 2 )}\end{matrix} & & \begin{matrix}{P}_{r , 1}^{( 1 )} * {P}_{r , 0 , 1 , {M}_{v} - 1}^{( 2 )} * \\ {φ}_{r , 0 , 1 , {M}_{v} - 1}^{( 2 )}\end{matrix} \\ \begin{matrix}{P}_{r , 1}^{( 1 )} * {P}_{r , 1 , 1 , 0}^{( 2 )} * \\ {φ}_{r , 1 , 1 , 0}^{( 2 )}\end{matrix} & \begin{matrix}{P}_{r , 1}^{( 1 )} * {P}_{r , 1 , 1 , 1}^{( 2 )} * \\ {φ}_{r , 1 , 1 , 1}^{( 2 )}\end{matrix} & & \begin{matrix}{P}_{r , 1}^{( 1 )} * {P}_{r , 1 , 1 , {M}_{v} - 1}^{( 2 )} * \\ {φ}_{r , 1 , 1 , {M}_{v} - 1}^{( 2 )}\end{matrix} \\ ⋮ & ⋮ & & ⋮ \\ \begin{matrix}{P}_{r , 1}^{( 1 )} * {P}_{r , {L}_{t} - 1 , 1 , 0}^{( 2 )} * \\ {φ}_{r , {L}_{t} - 1 , 1 , 0}^{( 2 )}\end{matrix} & \begin{matrix}{P}_{r , 1}^{( 1 )} * {P}_{r , {L}_{t} - 1 , 1 , 1}^{( 2 )} * \\ {φ}_{r , {L}_{t} - 1 , 1 , 1}^{( 2 )}\end{matrix} & & \begin{matrix}{P}_{r , 1}^{( 1 )} * {P}_{r , {L}_{t} - 1 , 1 , {M}_{v} - 1}^{( 2 )} * \\ {φ}_{r , {L}_{t} - 1 , 1 , {M}_{v} - 1}^{( 2 )}\end{matrix}\end{matrix} ]$$

In some embodiments, f may be an index of one third vector. For example, f=0, 1, . . . . Mᵥ−1.

In some embodiments, P_{r,s}⁽¹⁾ may be the second amplitude coefficient corresponding to layer with index r. In some embodiments, P_{r,s}⁽¹⁾ may not be needed. In some embodiments, P_{r,s}⁽¹⁾ may be fixed to be 1.

In some embodiments, P_{r,i,s,f}⁽²⁾ may be third amplitude coefficient corresponding to the layer with index r and corresponding to one first vector with index i and corresponding to third vector with index f.

In some embodiments, φ_{r,i,s,f}⁽²⁾ may be third amplitude coefficient corresponding to the layer with index r and corresponding to a first vector with index i and corresponding to third vector with index f.

In some embodiments, s may be 0 and/or 1. For example, s may be for two polarizations. In some embodiment, s may be for different groups of vectors.

In some embodiments, for third vectors (e.g. represented as W_{f}) corresponding to layer with index r, W_{f}=[Fₙ_{_{3,r}}_{⁽⁰⁾} Fₙ_{_{3,r}}_{⁽¹⁾} . . . . Fₙ_{_{3,r}}_{^{(Mv-1)}}]^{T}. In some embodiments, the size of W_{f} may be Mᵥ*N₃.

In some embodiments, n_{3,l}^{(f)}∈{0, 1, . . . , N₃−1}.

In some embodiments,

$${F}_{{n}_{3 , r}^{( f )}} = {[ \begin{matrix}1 & {e}^{j \frac{2 π * 1 * {n}_{3 , r}^{( f )}}{{N}_{3}}} & {e}^{j \frac{2 π * 2 * {n}_{3 , r}^{( f )}}{{N}_{3}}} … & {e}^{j \frac{2 π * ( {N}_{3} - 1 ) * {n}_{3 , r}^{( f )}}{{N}_{3}}}\end{matrix} ]}^{T} .$$

In some embodiments,

$${γ}_{z , r}^{( f )} = {e}^{j \frac{2 π * z * {n}_{3 , r}^{( f )}}{{N}_{3}}} .$$

In some embodiments, z may be an index of a second subband. For example, z={0, 1, . . . N₃−1}

In some embodiments, for the codebook corresponding to layer with index r and second subband with index z,

$${W}_{z}^{r} = \frac{1}{\sqrt{{N}_{1} {N}_{2} {γ}_{z , r}}} [ \begin{matrix}{\sum }_{i = 0}^{{L}_{t} - 1} {v}_{i} {P}_{r , 0}^{( 1 )} {\sum }_{f = 0}^{{M}_{υ} - 1} {y}_{z , r}^{( f )} {P}_{r , i , 0 , f}^{( 2 )} {φ}_{r , i , 0 , f}^{( 2 )} \\ {\sum }_{i = 0}^{{L}_{t} - 1} {v}_{i} {P}_{r , 1}^{( 1 )} {\sum }_{f = 0}^{{M}_{υ} - 1} {y}_{z , r}^{( f )} {P}_{r , i , 1 , f}^{( 2 )} {φ}_{r , i , 1 , f}^{( 2 )}\end{matrix} ]$$

In some embodiments, γ_{z,r} may be a variant for power calculation or power normalization.

In some embodiments, γ_{z,r} may be based on the plurality of third amplitude coefficients, the plurality of third phase coefficients and at least one of: the plurality of first amplitude coefficients, the plurality of second amplitude coefficients, the plurality of first phase coefficients and the plurality of second phase coefficients. In some embodiments, γ_{z,r} may be based on the number of the plurality of third vectors and at least one of: the number of the plurality of first vectors, the number of the plurality of second vectors and the number of the plurality of fourth vectors.

In some embodiments,

$${γ}_{t , 1} = {\sum }_{i = 0}^{2 L - 1} {( {p}_{l , ⌊ \frac{i}{L} ⌋}^{( 1} )}^{2} {\vert {\sum }_{f = 0}^{{M}_{υ} - 1} {γ}_{t , l}^{( f )} {p}_{l , i , f}^{( 2 )} {φ}_{l , i , f} \vert}^{2} . \qquad ( 1 )$$

In some embodiments, for bits or codepoints or values of the one or more indicators (or one or more bitmaps) for indicating nonzero coefficients with value to be 0, the third amplitude coefficient and/or the third phase coefficient corresponding to the bits or codepoints or values may be set to 0.

In some embodiments, the number of the plurality of first vectors may be based on the number of the plurality of second vectors and at least one of: the number of the first plurality of antenna port groups; the number of the second plurality of antenna port groups; and values of the plurality of first amplitude coefficients.

In some embodiments,

$${W}_{1} = [ \begin{matrix}{B}^{( 0 )} & 0 & 0 & 0 & 0 & 0 & 0 & 0 \\ 0 & {B}^{( 1 )} & 0 & 0 & 0 & 0 & 0 & 0 \\ 0 & 0 & ⋱ & 0 & 0 & 0 & 0 & 0 \\ 0 & 0 & 0 & {B}^{( T - 1 )} & 0 & 0 & 0 & 0 \\ 0 & 0 & 0 & 0 & {B}^{( 0 )} & 0 & 0 & 0 \\ 0 & 0 & 0 & 0 & 0 & {B}^{( 1 )} & 0 & 0 \\ 0 & 0 & 0 & 0 & 0 & 0 & ⋱ & 0 \\ 0 & 0 & 0 & 0 & 0 & 0 & 0 & {B}^{( T - 1 )}\end{matrix} ] .$$

In some embodiments,

$${W}_{1} = [ \begin{matrix}{σ}_{0} ( 0 ) * {B}^{( 0 )} & {σ}_{0} ( 0 ) * {B}^{( 1 )} & & {σ}_{0} ( T - 1 ) * {B}^{( T - 1 )} & 0 & 0 & & 0 \\ {σ}_{1} ( 0 ) * {B}^{( 0 )} & {σ}_{1} ( 1 ) * {B}^{( 1 )} & & {σ}_{1} ( T - 1 ) * {B}^{( T - 1 )} & 0 & 0 & & 0 \\ ⋮ & ⋮ & & ⋮ & 0 & 0 & & 0 \\ {σ}_{T - 1} ( 0 ) * {B}^{( 0 )} & {σ}_{T - 1} ( 1 ) * {B}^{( 1 )} & … & {σ}_{T - 1} ( T - 1 ) * {B}^{( T - 1 )} & 0 & 0 & … & 0 \\ 0 & 0 & & 0 & {σ}_{0} ( 0 ) * {B}^{( 0 )} & {σ}_{0} ( 0 ) * {B}^{( 1 )} & & {σ}_{0} ( T - 1 ) * {B}^{( T - 1 )} \\ 0 & 0 & & 0 & {σ}_{1} ( 0 ) * {B}^{( 0 )} & {σ}_{1} ( 1 ) * {B}^{( 1 )} & & {σ}_{1} ( T - 1 ) * {B}^{( T - 1 )} \\ 0 & 0 & & 0 & ⋮ & ⋮ & & ⋮ \\ 0 & 0 & & 0 & {σ}_{T - 1} ( 0 ) * {B}^{( 0 )} & {σ}_{T - 1} ( 1 ) * {B}^{( 1 )} & & {σ}_{T - 1} ( T - 1 ) * {B}^{( T - 1 )}\end{matrix} ]$$

In some embodiments, B^{(t)}=[vₗ_{ₜ}_{⁽⁰⁾}_{,m}_{ₜ}_{⁽⁰⁾} vₗ_{ₜ}_{⁽¹⁾}_{,m}_{ₜ}_{⁽¹⁾} . . . vₗ_{ₜ}_{^{(Lt-1)}}_{,m}_{ₜ}_{^{(Lt-1)}}].

In some embodiments, corresponding to a layer with index r,

$${\tilde{W}}_{2} = [ \begin{matrix}{P}_{0}^{( 0 )} * {φ}_{0}^{( 0 )} * {P}_{r , 0 , 0}^{( 1 )} * {P}_{r , 0 , 0 , 0 , 0}^{( 2 )} * {φ}_{r , 0 , 0 , 0 , 0}^{( 2 )} & & {P}_{0}^{( 0 )} * {φ}_{0}^{( 0 )} * {P}_{r , 0 , 0}^{( 1 )} * {P}_{r , 0 , 0 , 0 , {M}_{v} - 1}^{( 2 )} * {φ}_{r , 0 , 0 , 0 , {M}_{v} - 1}^{( 2 )} \\ {P}_{0}^{( 0 )} * {φ}_{0}^{( 0 )} * {P}_{r , 0 , 0}^{( 1 )} * {P}_{r , 0 , 1 , 0 , 0}^{( 2 )} * {φ}_{r , 0 , 1 , 0 , 0}^{( 2 )} & & {P}_{0}^{( 0 )} * {φ}_{0}^{( 0 )} * {P}_{r , 0 , 0}^{( 1 )} * {P}_{r , 0 , 1 , 0 , {M}_{v} - 1}^{( 2 )} * {φ}_{r , 0 , 1 , 0 , {M}_{v} - 1}^{( 2 )} \\ ⋮ & & ⋮ \\ {P}_{0}^{( 0 )} * {φ}_{0}^{( 0 )} * {P}_{r , 0 , 0}^{( 1 )} * {P}_{r , 0 , {L}_{0} - 1 , 0 , 0}^{( 2 )} * {φ}_{r , 0 , {L}_{0} - 1 , 0 , 0}^{( 2 )} & & {P}_{0}^{( 0 )} * {φ}_{0}^{( 0 )} * {P}_{r , 0 , 0}^{( 1 )} * {P}_{r , 0 , {L}_{0} - 1 , 0 , {M}_{v} - 1}^{( 2 )} * {φ}_{r , 0 , {L}_{0} - 1 , 0 , {M}_{v} - 1}^{( 2 )} \\ ⋮ & & ⋮ \\ {P}_{T - 1}^{( 0 )} * {φ}_{T - 1}^{( 0 )} * {P}_{r , T - 1 , 0}^{( 1 )} * {P}_{r , T - 1 , 0 , 0 , 0}^{( 2 )} * {φ}_{r , T - 1 , 0 , 0 , 0}^{( 2 )} & & {P}_{T - 1}^{( 0 )} * {φ}_{T - 1}^{( 0 )} * {P}_{r , T - 1 , 0}^{( 1 )} * {P}_{r , T - 1 , 0 , 0 , {M}_{v} - 1}^{( 2 )} * {φ}_{r , T - 1 , 0 , 0 , {M}_{v} - 1}^{( 2 )} \\ {P}_{T - 1}^{( 0 )} * {φ}_{T - 1}^{( 0 )} * {P}_{r , T - 1 , 0}^{( 1 )} * {P}_{r , T - 1 , 1 , 0 , 0}^{( 2 )} * {φ}_{r , T - 1 , 1 , 0 , 0}^{( 2 )} & & {P}_{T - 1}^{( 0 )} * {φ}_{T - 1}^{( 0 )} * {P}_{r , T - 1 , 0}^{( 1 )} * {P}_{r , T - 1 , 1 , 0 , {M}_{v} - 1}^{( 2 )} * {φ}_{r , T - 1 , 1 , 0 , {M}_{v} - 1}^{( 2 )} \\ ⋮ & & ⋮ \\ {P}_{T - 1}^{( 0 )} * {φ}_{T - 1}^{( 0 )} * {P}_{r , T - 1 , 1}^{( 1 )} * {P}_{r , T - 1 , {L}_{T - 1} - 1 , 0 , 0}^{( 2 )} * {φ}_{r , T - 1 , {L}_{T - 1} - 1 , 0 , 0}^{( 2 )} & … & {P}_{T - 1}^{( 0 )} * {φ}_{T - 1}^{( 0 )} * {P}_{r , T - 1 , 1}^{( 1 )} * {P}_{r , T - 1 , {L}_{T - 1} - 1 , 0 , {M}_{v} - 1}^{( 2 )} * {φ}_{r , T - 1 , {L}_{T - 1} - 1 , 0 , {M}_{v} - 1}^{( 2 )} \\ {P}_{0}^{( 0 )} * {φ}_{0}^{( 0 )} * {P}_{r , 0 , 1}^{( 1 )} * {P}_{r , 0 , 0 , 1 , 0}^{( 2 )} * {φ}_{r , 0 , 0 , 1 , 0}^{( 2 )} & & {P}_{0}^{( 0 )} * {φ}_{0}^{( 0 )} * {P}_{r , 0 , 1}^{( 1 )} * {P}_{r , 0 , 0 , 1 , {M}_{v} - 1}^{( 2 )} * {φ}_{r , 0 , 0 , 1 , {M}_{v} - 1}^{( 2 )} \\ {P}_{0}^{( 0 )} * {φ}_{0}^{( 0 )} * {P}_{r , 0 , 1}^{( 1 )} * {P}_{r , 0 , 1 , 1 , 0}^{( 2 )} * {φ}_{r , 0 , 1 , 1 , 0}^{( 2 )} & & {P}_{0}^{( 0 )} * {φ}_{0}^{( 0 )} * {P}_{r , 0 , 1}^{( 1 )} * {P}_{r , 0 , 1 , 1 , {M}_{v} - 1}^{( 2 )} * {φ}_{r , 0 , 1 , 1 , {M}_{v} - 1}^{( 2 )} \\ ⋮ & & ⋮ \\ {P}_{0}^{( 0 )} * {φ}_{0}^{( 0 )} * {P}_{r , 0 , 1}^{( 1 )} * {P}_{r , 0 , {L}_{0} - 1 , 1 , 0}^{( 2 )} * {φ}_{r , 0 , {L}_{0} - 1 , 1 , 0}^{( 2 )} & & {P}_{0}^{( 0 )} * {φ}_{0}^{( 0 )} * {P}_{r , 0 , 1}^{( 1 )} * {P}_{r , 0 , {L}_{0} - 1 , 1 , {M}_{v} - 1}^{( 2 )} * {φ}_{r , 0 , {L}_{0} - 1 , 1 , {M}_{v} - 1}^{( 2 )} \\ ⋮ & & ⋮ \\ {P}_{T - 1}^{( 0 )} * {φ}_{T - 1}^{( 0 )} * {P}_{r , T - 1 , 1}^{( 1 )} * {P}_{r , T - 1 , 0 , 1 , 0}^{( 2 )} * {φ}_{r , T - 1 , 0 , 1 , 0}^{( 2 )} & & {P}_{T - 1}^{( 0 )} * {φ}_{T - 1}^{( 0 )} * {P}_{r , T - 1 , 1}^{( 1 )} * {P}_{r , T - 1 , 0 , 1 , {M}_{v} - 1}^{( 2 )} * {φ}_{r , T - 1 , 0 , 1 , {M}_{v} - 1}^{( 2 )} \\ {P}_{T - 1}^{( 0 )} * {φ}_{T - 1}^{( 0 )} * {P}_{r , T - 1 , 1}^{( 1 )} * {P}_{r , T - 1 , 1 , 1 , 0}^{( 2 )} * {φ}_{r , T - 1 , 1 , 1 , 0}^{( 2 )} & & {P}_{T - 1}^{( 0 )} * {φ}_{T - 1}^{( 0 )} * {P}_{r , T - 1 , 1}^{( 1 )} * {P}_{r , T - 1 , 1 , 1 , {M}_{v} - 1}^{( 2 )} * {φ}_{r , T - 1 , 1 , 1 , {M}_{v} - 1}^{( 2 )} \\ ⋮ & & ⋮ \\ {P}_{T - 1}^{( 0 )} * {φ}_{T - 1}^{( 0 )} * {P}_{r , T - 1 , 1}^{( 1 )} * {P}_{r , T - 1 , {L}_{T - 1} - 1 , 1 , 0}^{( 2 )} * {φ}_{r , T - 1 , {L}_{t - 1} - 1 , 1 , 0}^{( 2 )} & & {P}_{T - 1}^{( 0 )} * {φ}_{T - 1}^{( 0 )} * {P}_{r , T - 1 , 1}^{( 1 )} * {P}_{r , T - 1 , {L}_{T - 1} - 1 , 1 , {M}_{v} - 1}^{( 2 )} * {φ}_{r , T - 1 , {L}_{t - 1} - 1 , 1 , {M}_{v} - 1}^{( 2 )}\end{matrix} ]$$

In some embodiments, Pₜ⁽⁰⁾ may be the first amplitude coefficient for antenna port group with index t. In some embodiments, Pₜ⁽⁰⁾ may not be needed. In some embodiments, Pₜ⁽⁰⁾ may be fixed to be 1.

In some embodiments, φₜ⁽⁰⁾ may be the first phase coefficient for antenna port group with index t. In some embodiments, φₜ⁽⁰⁾ may not be needed. In some embodiments, φₜ⁽⁰⁾ may be fixed to be 1.

In some embodiments, P_{r,t,s}⁽¹⁾ may be the second amplitude coefficient corresponding to antenna port group with index t and corresponding to layer with index r. In some embodiments, P_{r,t,s}⁽¹⁾ may not be needed. In some embodiments, P_{r,t,s}⁽¹⁾ may be fixed to be 1.

In some embodiments, P_{r,t,i,s,f}⁽²⁾ may be third amplitude coefficient for antenna port group with index t and corresponding to the layer with index r and corresponding to one first vector with index i and corresponding to third vector with index f.

In some embodiments, φ_{r,t,i,s,f}⁽²⁾ may be third amplitude coefficient for antenna port group with index t and corresponding to the layer with index r and corresponding to a first vector with index i and corresponding to third vector with index f.

In some embodiments, for third vectors (e.g. represented as W_{f}) corresponding to layer with index r, W_{f}=[Fₙ_{_{3,r}}_{⁽⁰⁾} Fₙ_{_{3,r}}_{⁽¹⁾} . . . Fₙ_{_{3,r}}_{^{(Mv-1)}}]^{T}. In some embodiments, the size of W_{f} may be Mᵥ*N₃.

In some embodiments, n_{3,l}^{(f)}∈{0, 1, . . . , N₃−1}.

In some embodiments,

$${F}_{{n}_{3 , r}^{( f )}} = {[ \begin{matrix}1 & {e}^{j \frac{2 π * 1 * {n}_{3 , r}^{( f )}}{{N}_{3}}} & {e}^{j \frac{2 π * 2 * {n}_{3 , r}^{( f )}}{{N}_{3}}} … {e}^{j \frac{2 π * ( {N}_{3} - 1 ) * {n}_{3 , r}^{( f )}}{{N}_{3}}}\end{matrix} ]}^{T} .$$

In some embodiments, for the codebook corresponding to layer with index r and second subband with index z,

$${W}_{z}^{r} = \frac{1}{\sqrt{{N}_{1} {N}_{2} {γ}_{z , r}}} [ \begin{matrix}{\sum }_{t = 0}^{T - 1} {P}_{t}^{( 0 )} {φ}_{t}^{( 0 )} {\sum }_{i = 0}^{{L}_{t} - 1} {v}_{{l}_{t}^{( i )} , {m}_{t}^{( i )}} {P}_{r , t , 0}^{( 1 )} {\sum }_{f = 0}^{{M}_{υ} - 1} {y}_{z , r}^{( f )} {P}_{r , t , i , 0 , f}^{( 2 )} {φ}_{r , t , i , 0 , f}^{( 2 )} \\ {\sum }_{t = 0}^{T - 1} {P}_{t}^{( 0 )} {φ}_{t}^{( 0 )} {\sum }_{i = 0}^{{L}_{t} - 1} {v}_{{l}_{t}^{( i )} , {m}_{t}^{( i )}} {P}_{r , t , 1}^{( 1 )} {\sum }_{f = 0}^{{M}_{υ} - 1} {y}_{z , r}^{( f )} {P}_{r , t , i , 1 , f}^{( 2 )} {φ}_{r , t , i , 1 , f}^{( 2 )}\end{matrix} ] .$$

In some embodiments, a first vector corresponding to a third subband with an index may be determined based on one or more second vectors, one or more first amplitude coefficients corresponding to the third subband with the index, and one or more first phase coefficients corresponding to the third subband with the index.

In some embodiments, P_{t,X}⁽⁰⁾ may be the first amplitude coefficient for antenna port group with index t and corresponding to the third subband X. In some embodiments, P_{t,X}⁽⁰⁾ may not be needed. In some embodiments, P_{t,X}⁽⁰⁾ may be fixed to be 1.

In some embodiments, φ_{t,X}⁽⁰⁾ may be the first phase coefficient for antenna port group with index t and corresponding to the third subband X. In some embodiments, φ_{t,X}⁽⁰⁾ may not be needed. In some embodiments, φ_{t,X}⁽⁰⁾ may be fixed to be 1.

In some embodiments, X may be an index for one third subband. For example, X∈{0, 1, . . . . N₄−1}.

In some embodiments, a first vector corresponding to third subband X may be v_{i,X},

$${v}_{i , X} = [ \begin{matrix}{v}_{{l}_{0}^{( i )} , {m}_{0}^{( i )}} * {P}_{0 , X}^{( 0 )} * {φ}_{0 , X}^{( 0 )} \\ {v}_{{l}_{1}^{( i )} , {m}_{1}^{( i )}} * {P}_{1 , X}^{( 0 )} * {φ}_{1 , X}^{( 0 )} \\ ⋮ \\ {v}_{{l}_{T - 1}^{( i )} , {m}_{T - 1}^{( i )}} * {P}_{T - 1 , X}^{( 0 )} * {φ}_{T - 1 , X}^{( 0 )}\end{matrix} ] .$$

In some embodiments,

$${W}_{1 , X} = [ \begin{matrix}B & 0 \\ 0 & B\end{matrix} ] .$$

In some embodiments, B=v₀v₁ . . . v_{L}_{ₜ}₋₁.

In some embodiments, the size of W_{1,X} may be (2*N₁*N₂)*(2*Lₜ).

In some embodiments, the size of each element in W_{1,X} may be (N₁*N₂)*Lₜ, “0” in W_{1,X} may be a zero matrix with size (N₁*N₂)*Lₜ.

In some embodiments,

$${W}_{1 , X} = [ \begin{matrix}{v}_{0 , X} {v}_{1 , X} … {v}_{{L}_{t} - 1 , X} & 0 \\ 0 & {v}_{0 , X} {v}_{1 , X} … {v}_{{L}_{t} - 1 , X}\end{matrix} ] .$$

In some embodiments, W_{1,X}=W_{01,X}*W_{02,X}.

In some embodiments,

$${W}_{01 , X} = [ \begin{matrix}{B}^{( 0 )} & 0 & 0 & 0 & 0 & 0 & 0 & 0 \\ 0 & {B}^{( 1 )} & 0 & 0 & 0 & 0 & 0 & 0 \\ 0 & 0 & ⋱ & 0 & 0 & 0 & 0 & 0 \\ 0 & 0 & 0 & {B}^{( T - 1 )} & 0 & 0 & 0 & 0 \\ 0 & 0 & 0 & 0 & {B}^{( 0 )} & 0 & 0 & 0 \\ 0 & 0 & 0 & 0 & 0 & {B}^{( 1 )} & 0 & 0 \\ 0 & 0 & 0 & 0 & 0 & 0 & ⋱ & 0 \\ 0 & 0 & 0 & 0 & 0 & 0 & 0 & {B}^{( T - 1 )}\end{matrix} ] .$$

In some embodiments,

$${W}_{01 , X} = [ \begin{matrix}{σ}_{0} ( 0 ) * {B}^{( 0 )} & {σ}_{0} ( 0 ) * {B}^{( 1 )} & & {σ}_{0} ( T - 1 ) * {B}^{( T - 1 )} & 0 & 0 & & 0 \\ {σ}_{1} ( 0 ) * {B}^{( 0 )} & {σ}_{1} ( 1 ) * {B}^{( 1 )} & & {σ}_{1} ( T - 1 ) * {B}^{( T - 1 )} & 0 & 0 & & 0 \\ ⋮ & ⋮ & & ⋮ & 0 & 0 & & 0 \\ {σ}_{T - 1} ( 0 ) * {B}^{( 0 )} & {σ}_{T - 1} ( 1 ) * {B}^{( 1 )} & … & {σ}_{T - 1} ( T - 1 ) * {B}^{( T - 1 )} & 0 & 0 & … & 0 \\ 0 & 0 & & 0 & {σ}_{0} ( 0 ) * {B}^{( 0 )} & {σ}_{0} ( 0 ) * {B}^{( 1 )} & & {σ}_{0} ( T - 1 ) * {B}^{( T - 1 )} \\ 0 & 0 & & 0 & {σ}_{1} ( 0 ) * {B}^{( 0 )} & {σ}_{1} ( 1 ) * {B}^{( 1 )} & & {σ}_{1} ( T - 1 ) * {B}^{( T - 1 )} \\ 0 & 0 & & 0 & ⋮ & ⋮ & & ⋮ \\ 0 & 0 & & 0 & {σ}_{T - 1} ( 0 ) * {B}^{( 0 )} & {σ}_{T - 1} ( 1 ) * {B}^{( 1 )} & & {σ}_{T - 1} ( T - 1 ) * {B}^{( T - 1 )}\end{matrix} ]$$

In some embodiments, first vector may be

$${v}_{i , X} = [ \begin{matrix}{\sum }_{t = 0}^{T - 1} {σ}_{0} ( t ) * {v}_{{l}_{t}^{( i )} , {m}_{t}^{( i )}} * {P}_{t , X}^{( 0 )} * {φ}_{t , X}^{( 0 )} \\ {\sum }_{t = 0}^{T - 1} {σ}_{1} ( t ) * {v}_{{l}_{t}^{( i )} , {m}_{t}^{( i )}} * {P}_{t , X}^{( 0 )} * {φ}_{t , X}^{( 0 )} \\ ⋮ \\ {\sum }_{t = 0}^{T - 1} {σ}_{T - 1} ( t ) * {v}_{{l}_{t}^{( i )} , {m}_{t}^{( i )}} * {P}_{t , X}^{( 0 )} * {φ}_{t , X}^{( 0 )}\end{matrix} ] .$$

In some embodiments, B^{(t)}=[vₗ_{ₜ}_{⁽⁰⁾}_{,m}_{ₜ}_{⁽⁰⁾} vₗ_{ₜ}_{⁽¹⁾}_{,m}_{ₜ}_{⁽¹⁾} . . . vₗ_{ₜ}_{^{(Lt-1)}}_{,m}_{ₜ}_{^{(Lt-1)}}].

In some embodiments,

$${W}_{02 , X} = [ \begin{matrix}{P}_{0 , X}^{( 0 )} * {φ}_{0 , X}^{( 0 )} \\ {P}_{1 , X}^{( 0 )} * {φ}_{1 , X}^{( 0 )} \\ ⋮ \\ {P}_{T - 1 , X}^{( 0 )} * {φ}_{T - 1 , X}^{( 0 )} \\ {P}_{0 , X}^{( 0 )} * {φ}_{0 , X}^{( 0 )} \\ {P}_{1 , X}^{( 0 )} * {φ}_{1 , X}^{( 0 )} \\ ⋮ \\ {P}_{T - 1 , X}^{( 0 )} * {φ}_{T - 1 , X}^{( 0 )}\end{matrix} ] .$$

In some embodiments,

$${W}_{1} = [ \begin{matrix}B & 0 \\ 0 & B\end{matrix} ] = {W}_{01} * {W}_{02} = [ \begin{matrix}{B}^{( 0 )} & 0 & 0 & 0 & 0 & 0 & 0 & 0 \\ 0 & {B}^{( 1 )} & 0 & 0 & 0 & 0 & 0 & 0 \\ 0 & 0 & ⋱ & 0 & 0 & 0 & 0 & 0 \\ 0 & 0 & 0 & {B}^{( T - 1 )} & 0 & 0 & 0 & 0 \\ 0 & 0 & 0 & 0 & {B}^{( 0 )} & 0 & 0 & 0 \\ 0 & 0 & 0 & 0 & 0 & {B}^{( 1 )} & 0 & 0 \\ 0 & 0 & 0 & 0 & 0 & 0 & ⋱ & 0 \\ 0 & 0 & 0 & 0 & 0 & 0 & 0 & {B}^{( T - 1 )}\end{matrix} ] * [ \begin{matrix}{P}_{0 , X}^{( 0 )} * {φ}_{0 , X}^{( 0 )} \\ {P}_{1 , X}^{( 0 )} * {φ}_{1 , X}^{( 0 )} \\ ⋮ \\ {P}_{T - 1 , X}^{( 0 )} * {φ}_{T - 1 , X}^{( 0 )} \\ {P}_{0 , X}^{( 0 )} * {φ}_{0 , X}^{( 0 )} \\ {P}_{1 , X}^{( 0 )} * {φ}_{1 , X}^{( 0 )} \\ ⋮ \\ {P}_{T - 1 , X}^{( 0 )} * {φ}_{T - 1 , X}^{( 0 )}\end{matrix} ]$$

In some embodiments, for W₂ corresponding to layer with index r:

$${\tilde{W}}_{2} = [ \begin{matrix}{P}_{r , 0}^{( 1 )} * {P}_{r , 0 , 0 , 0}^{( 2 )} * {φ}_{r , 0 , 0 , 0}^{( 2 )} & {P}_{r , 0}^{( 1 )} * {P}_{r , 0 , 0 , 0}^{( 2 )} * {φ}_{r , 0 , 0 , 0}^{( 2 )} & & {P}_{r , 0}^{( 1 )} * {P}_{r , 0 , {M}_{v} - 1}^{( 2 )} * {φ}_{r , 0 , 0 , {M}_{v} - 1}^{( 2 )} \\ {P}_{r , 0}^{( 1 )} * {P}_{r , 1 , 0 , 0}^{( 2 )} * {φ}_{r , 1 , 0 , 0}^{( 2 )} & {P}_{r , 0}^{( 1 )} * {P}_{r , 1 , 0 , 0}^{( 2 )} * {φ}_{r , 1 , 0 , 0}^{( 2 )} & & {P}_{r , 0}^{( 1 )} * {P}_{r , 1 , 0 , {M}_{v} - 1}^{( 2 )} * {φ}_{r , 1 , 0 , {M}_{v} - 1}^{( 2 )} \\ ⋮ & ⋮ & & ⋮ \\ {P}_{r , 0}^{( 1 )} * {P}_{r , {L}_{t} - 1 , 0 , 0}^{( 2 )} * {φ}_{r , {L}_{t} - 1 , 0 , 0}^{( 2 )} & {P}_{r , 0}^{( 1 )} * {P}_{r , {L}_{t} - 1 , 0 , 0}^{( 2 )} * {φ}_{r , {L}_{t} - 1 , 0 , 0}^{( 2 )} & … & {P}_{r , 0}^{( 1 )} * {P}_{r , {L}_{t} - 1 , 0 , {M}_{v} - 1}^{( 2 )} * {φ}_{r , {L}_{t} - 1 , 0 , {M}_{v} - 1}^{( 2 )} \\ {P}_{r , 1}^{( 1 )} * {P}_{r , 0 , 1 , 0}^{( 2 )} * {φ}_{r , 0 , 1 , 0}^{( 2 )} & {P}_{r , 1}^{( 1 )} * {P}_{r , 0 , 1 , 0}^{( 2 )} * {φ}_{r , 0 , 1 , 0}^{( 2 )} & & {P}_{r , 1}^{( 1 )} * {P}_{r , 0 , 1 , {M}_{v} - 1}^{( 2 )} * {φ}_{r , 0 , 1 , {M}_{v} - 1}^{( 2 )} \\ {P}_{r , 1}^{( 1 )} * {P}_{r , 1 , 1 , 0}^{( 2 )} * {φ}_{r , 1 , 1 , 0}^{( 2 )} & {P}_{r , 1}^{( 1 )} * {P}_{r , 1 , 1 , 0}^{( 2 )} * {φ}_{r , 1 , 1 , 0}^{( 2 )} & & {P}_{r , 1}^{( 1 )} * {P}_{r , 1 , 1 , {M}_{v} - 1}^{( 2 )} * {φ}_{r , 1 , 1 , {M}_{v} - 1}^{( 2 )} \\ ⋮ & ⋮ & & ⋮ \\ {P}_{r , 1}^{( 1 )} * {P}_{r , {L}_{t} - 1 , 1 , 0}^{( 2 )} * {φ}_{r , {L}_{t} - 1 , 1 , 0}^{( 2 )} & {P}_{r , 1}^{( 1 )} * {P}_{r , {L}_{t} - 1 , 1 , 0}^{( 2 )} * {φ}_{r , {L}_{t} - 1 , 1 , 0}^{( 2 )} & & {P}_{r , 1}^{( 1 )} * {P}_{r , {L}_{t} - 1 , 1 , {M}_{v} - 1}^{( 2 )} * {φ}_{r , {L}_{t} - 1 , 1 , {M}_{v} - 1}^{( 2 )}\end{matrix} ]$$

In some embodiments, for the codebook corresponding to layer with index r and second subband with index z,

$${W}_{z}^{r} = \frac{1}{\sqrt{{N}_{1} {N}_{2} {γ}_{z , r}}} [ \begin{matrix}{\sum }_{t = 0}^{T - 1} {P}_{t , X}^{( 0 )} {φ}_{t , X}^{( 0 )} {\sum }_{i = 0}^{{L}_{t} - 1} {v}_{{l}_{t}^{( i )} , {m}_{t}^{( i )}} {P}_{r , 0}^{( 1 )} {\sum }_{f = 0}^{{M}_{v} - 1} {y}_{z , r}^{( f )} {P}_{r , i , 0 , f}^{( 2 )} {φ}_{r , i , 0 , f}^{( 2 )} \\ {\sum }_{t = 0}^{T - 1} {P}_{t , X}^{( 0 )} {φ}_{t , X}^{( 0 )} {\sum }_{i = 0}^{{L}_{t} - 1} {v}_{{l}_{t}^{( i )} , {m}_{t}^{( i )}} {P}_{r , 1}^{( 1 )} {\sum }_{f = 0}^{{M}_{v} - 1} {y}_{z , r}^{( f )} {P}_{r , i , 1 , f}^{( 2 )} {φ}_{r , i , 1 , f}^{( 2 )}\end{matrix} ]$$

In some embodiments,

$$X = ⌊ \frac{z}{{R}_{w}} ⌋ .$$

In some embodiments, X=└R_{w}·z┘.

In some embodiments, for fourth vectors (e.g. represented as W_{fw}) corresponding to layer with index r, W_{fw}=[Fₙ_{₄}_{⁽⁰⁾} Fₙ_{₄}_{⁽¹⁾} . . . Fₙ_{₄}_{^{(Mw-1)}}]^{T}. In some embodiments, the size of W_{fw} may be M_{w}*N₄.

In some embodiments, n₄^{(f)}∈{0, 1, . . . , N₃−1}.

In some embodiments,

$${F}_{{n}_{4}^{( f )}} = [ \begin{matrix}1 & {e}^{j \frac{2 π * 1 * {n}_{4}^{( f )}}{{N}_{4}}} & {e}^{j \frac{2 π * 2 * {n}_{4}^{( f )}}{{N}_{4}}} & ... & {{e}^{j \frac{2 π * ( {N}_{4} - 1 ) * {n}_{4}^{( f )}}{{N}_{4}}} ]}^{T} .\end{matrix}$$

In some embodiments,

$${d}_{X}^{( f )} = {e}^{j \frac{2 π * X * {n}_{4}^{( f )}}{{N}_{4}}} .$$

In some embodiments, W₁=W₀₁*W₀₂*W_{fw}.

In some embodiments, fw may be an index of one third vector. For example, fw=0, 1, . . . . M_{w}−1.

In some embodiments, a first vector corresponding to a third subband with an index may be determined based on one or more second vectors, one or more fourth vectors, one or more first amplitude coefficients corresponding to the third subband with the index, and one or more first phase coefficients corresponding to the third subband with the index

In some embodiments, P_{t,f,w}⁽⁰⁾ may be the first amplitude coefficient for antenna port group with index t and corresponding to one fourth vector with index fw. In some embodiments, P_{t,f,w}⁽⁰⁾ may not be needed. In some embodiments, P_{t,f,w}⁽⁰⁾ may be fixed to be 1.

In some embodiments, φ_{t,fw}⁽⁰⁾ may be the first phase coefficient for antenna port group with index t and corresponding to one fourth vector with index f_{w}. In some embodiments, φ_{t,f,w}⁽⁰⁾ may not be needed. In some embodiments, φ_{t,f,w}⁽⁰⁾ may be fixed to be 1.

In some embodiments,

$${W}_{02} = [ \begin{matrix}{P}_{0 , 0}^{( 0 )} * {φ}_{0 , 0}^{( 0 )} & & {P}_{0 , fw}^{( 0 )} * {φ}_{0 , fw}^{( 0 )} \\ {P}_{1 , 0}^{( 0 )} * {φ}_{1 , 0}^{( 0 )} & & {P}_{1 , X}^{( 0 )} * {φ}_{1 , fw}^{( 0 )} \\ ⋮ & & ⋮ \\ {P}_{T - 1 , 0}^{( 0 )} * {φ}_{T - 1 , 0}^{( 0 )} & ... & {P}_{T - 1 , fw}^{( 0 )} * {φ}_{T - 1 , fw}^{( 0 )} \\ {P}_{0 , 0}^{( 0 )} * {φ}_{0 , 0}^{( 0 )} & & {P}_{0 , fw}^{( 0 )} * {φ}_{0 , fw}^{( 0 )} \\ {P}_{1 , 0}^{( 0 )} * {φ}_{1 , 0}^{( 0 )} & & {P}_{1 , fw}^{( 0 )} * {φ}_{1 , fw}^{( 0 )} \\ ⋮ & & ⋮ \\ {P}_{T - 1 , 0}^{( 0 )} * {φ}_{T - 1 , 0}^{( 0 )} & & {P}_{T - 1 , fw}^{( 0 )} * {φ}_{T - 1 , fw}^{( 0 )}\end{matrix} ] .$$

In some embodiments, W₁=W₀₁*W₀₂*W_{fw}.

In some embodiments, first vector may be

$${v}_{i , X} = {\sum }_{i = 0}^{{L}_{t} - 1} {v}_{{l}_{t}^{( i )} , {m}_{t}^{( i )}} {\sum }_{fw = 0}^{{M}_{w} - 1} {d}_{X}^{( f )} {P}_{t , fw}^{( 0 )} {φ}_{t , fw}^{( 0 )} .$$

In some embodiments, for W₁ corresponding to third subband with index X,

$${W}_{1 , X} = [ \begin{matrix}{B}_{X} & 0 \\ 0 & {B}_{X}\end{matrix} ] = [ \begin{matrix}{v}_{0 , X} {v}_{1 , X} … {v}_{{L}_{t} , X} & 0 \\ 0 & {v}_{0 , X} {v}_{1 , X} … {v}_{{L}_{t} , X}\end{matrix} ] .$$

In some embodiments, B=v₀v₁ . . . v_{L}_{ₜ}₋₁.

In some embodiments, the size of W_{1,X} may be (2*N₁*N₂)*(2*Lₜ).

In some embodiments, the size of each element in W_{1,X} may be (N₁*N₂)*Lₜ, “0” in W_{1,X} may be a zero matrix with size (N₁*N₂)*Lₜ.

In some embodiments, for W₂ corresponding to layer with index r:

$${\tilde{W}}_{2} = [ \begin{matrix}{P}_{r , 0}^{( 1 )} * {P}_{r , 0 , 0 , 0}^{( 2 )} * {φ}_{r , 0 , 0 , 0}^{( 2 )} & {P}_{r , 0}^{( 1 )} * {P}_{r , 0 , 1}^{( 2 )} * {φ}_{r , 0 , 0 , 1}^{( 2 )} & {P}_{r , 0}^{( 1 )} * {P}_{r , 0 , {M}_{v} - 1}^{( 2 )} * {φ}_{r , 0 , 0 , {M}_{v} - 1}^{( 2 )} \\ {P}_{r , 0}^{( 1 )} * {P}_{r , 1 , 0 , 0}^{( 2 )} * {φ}_{r , 1 , 0 , 0}^{( 2 )} & {P}_{r , 0}^{( 1 )} * {P}_{r , 1 , 0 , 1}^{( 2 )} * {φ}_{r , 1 , 0 , 1}^{( 2 )} & {P}_{r , 0}^{( 1 )} * {P}_{r , 1 , 0 , {M}_{v} - 1}^{( 2 )} * {φ}_{r , 1 , 0 , {M}_{v} - 1}^{( 2 )} \\ ⋮ & ⋮ & ⋮ \\ {P}_{r , 0}^{( 1 )} * {P}_{r , {L}_{t} - 1 , 0 , 0}^{( 2 )} * {φ}_{r , {L}_{t} - 1 , 0 , 0}^{( 2 )} & {P}_{r , 0}^{( 1 )} * {P}_{r , {L}_{t} - 1 , 0 , 1}^{( 2 )} * {φ}_{r , {L}_{t} - 1 , 0 , 1}^{( 2 )} & {P}_{r , 0}^{( 1 )} * {P}_{r , {L}_{t} - 1 , 0 , {M}_{v} - 1}^{( 2 )} * {φ}_{r , {L}_{t} - 1 , 0 , {M}_{v} - 1}^{( 2 )} \\ {P}_{r , 1}^{( 1 )} * {P}_{r , 0 , 1 , 0}^{( 2 )} * {φ}_{r , 0 , 1 , 0}^{( 2 )} & {P}_{r , 1}^{( 1 )} * {P}_{r , 0 , 1 , 1}^{( 2 )} * {φ}_{r , 0 , 1 , 1}^{( 2 )} & {P}_{r , 1}^{( 1 )} * {P}_{r , 0 , 1 , {M}_{v} - 1}^{( 2 )} * {φ}_{r , 0 , 1 , {M}_{v} - 1}^{( 2 )} \\ {P}_{r , 1}^{( 1 )} * {P}_{r , 1 , 1 , 0}^{( 2 )} * {φ}_{r , 1 , 1 , 0}^{( 2 )} & {P}_{r , 1}^{( 1 )} * {P}_{r , 1 , 1 , 1}^{( 2 )} * {φ}_{r , 1 , 1 , 1}^{( 2 )} & {P}_{r , 1}^{( 1 )} * {P}_{r , 1 , 1 , {M}_{v} - 1}^{( 2 )} * {φ}_{r , 1 , 1 , {M}_{v} - 1}^{( 2 )} \\ ⋮ & ⋮ & ⋮ \\ {P}_{r , 1}^{( 1 )} * {P}_{r , {L}_{t} - 1 , 1 , 0}^{( 2 )} * {φ}_{r , {L}_{t} - 1 , 1 , 0}^{( 2 )} & {P}_{r , 1}^{( 1 )} * {P}_{r , {L}_{t} - 1 , 1 , 1}^{( 2 )} * {φ}_{r , {L}_{t} - 1 , 1 , 1}^{( 2 )} & {P}_{r , 1}^{( 1 )} * {P}_{r , {L}_{t} - 1 , 1 , {M}_{v} - 1}^{( 2 )} * {φ}_{r , {L}_{t} - 1 , 1 , {M}_{v} - 1}^{( 2 )}\end{matrix} ]$$

In some embodiments, for the codebook corresponding to layer with index r and second subband with index z,

$${W}_{z}^{r} = \frac{1}{\sqrt{{N}_{1} {N}_{2} {γ}_{z , r}}} [ \begin{matrix}{\sum }_{i = 0}^{{L}_{t} - 1} {v}_{i , X} {P}_{r , t , 0}^{( 1 )} {\sum }_{f = 0}^{{M}_{v} - 1} {y}_{z , r}^{( f )} {P}_{r , t , i , 0 , f}^{( 2 )} {φ}_{r , t , i , 0 , f}^{( 2 )} \\ {\sum }_{i = 0}^{{L}_{t} - 1} {v}_{i , X} {P}_{r , t , 1}^{( 1 )} {\sum }_{f = 0}^{{M}_{v} - 1} {y}_{z , r}^{( f )} {P}_{r , t , i , 1 , f}^{( 2 )} {φ}_{r , t , i , 1 , f}^{( 2 )}\end{matrix} ]$$

In some embodiments, a length of first vector may be based on the number of second plurality of antenna port groups. In some embodiments, the plurality of first vectors may be determined based on different codebook tables, wherein the different codebook tables may be based on the number of second plurality of antenna port groups and the at least one parameter for antenna port configuration.

In some embodiments, the length of one first vector may be determined based on the number of first plurality of antenna port groups or the number of second plurality of antenna port groups.

In some embodiments,

$${W}_{1} = [ \begin{matrix}B & 0 \\ 0 & B\end{matrix} ] ,$$

B=v₀v₁ . . . v_{L}_{ₜ}₋₁, size of W₁ may be (2*N₁*N₂)*(2*Lₜ).

In some embodiments, a value of one first amplitude coefficient may be at least one of

$$\{ 0 , \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \\ \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} .$$

In some embodiments, the bit size for one first amplitude coefficient may be 4 bits. In some embodiments, a value of an indicator or a field for one first amplitude coefficient may be at least one of {0, 1, 2, 3, 4, 5, 6, 7, 8, 9, 10, 11, 12, 13, 14, 15}. In some embodiments, an indicator or a field for one first amplitude coefficient with value 0 may correspond to the first amplitude coefficient with value 0. In some embodiments, an indicator or a field for one first amplitude coefficient with value 1 may correspond to the first amplitude coefficient with value

$$\frac{1}{\sqrt{128}} .$$

In some embodiments, an indicator or a field for one first amplitude coefficient with value 2 may correspond to the first amplitude coefficient with value

$${( \frac{1}{8192} )}^{1 / 4} .$$

In some embodiments, an indicator or a field for one first amplitude coefficient with value 3 may correspond to the first amplitude coefficient with value ⅛. In some embodiments, an indicator or a field for one first amplitude coefficient with value 4 may correspond to the first amplitude coefficient with value

$${( \frac{1}{2048} )}^{1 / 4} .$$

In some embodiments, an indicator or a field for one first amplitude coefficient with value 5 may correspond to the first amplitude coefficient with value

$$\frac{1}{2 \sqrt{8}} .$$

In some embodiments, an indicator or a field for one first amplitude coefficient with value 6 may correspond to the first amplitude coefficient with value

$${( \frac{1}{512} )}^{1 / 4} .$$

In some embodiments, an indicator or a field for one first amplitude coefficient with value 7 may correspond to the first amplitude coefficient with value ¼. In some embodiments, an indicator or a field for one first amplitude coefficient with value 8 may correspond to the first amplitude coefficient with value

$${( \frac{1}{128} )}^{1 / 4} .$$

In some embodiments, an indicator or a field for one first amplitude coefficient with value 9 may correspond to the first amplitude coefficient with value

$$\frac{1}{\sqrt{8}} .$$

In some embodiments, an indicator or a field for one first amplitude coefficient with value 10 may correspond to the first amplitude coefficient with value

$${( \frac{1}{32} )}^{1 / 4} .$$

In some embodiments, an indicator or a field for one first amplitude coefficient with value 11 may correspond to the first amplitude coefficient with value ½. In some embodiments, an indicator or a field for one first amplitude coefficient with value 12 may correspond to the first amplitude coefficient with value

$${( \frac{1}{8} )}^{1 / 4} .$$

In some embodiments, an indicator or a field for one first amplitude coefficient with value 13 may correspond to the first amplitude coefficient with value

$$\frac{1}{\sqrt{2}} .$$

In some embodiments, an indicator or a field for one first amplitude coefficient with value 14 may correspond to the first amplitude coefficient with value

$${( \frac{1}{2} )}^{1 / 4} .$$

In some embodiments, an indicator or a field for one first amplitude coefficient with value 15 may correspond to the first amplitude coefficient with value 1.

In some embodiments, a value of one first amplitude coefficient may be at least one of

$$\{ 0 , \frac{1}{\sqrt{64}} , \frac{1}{\sqrt{32}} , \frac{1}{4} , \frac{1}{\sqrt{8}} , \frac{1}{2} , \frac{1}{\sqrt{2}} , 1 \} .$$

In some embodiments, the bit size for one first amplitude coefficient may be 4 bits. In some embodiments, a value of an indicator or a field for one first amplitude coefficient may be at least one of {0, 1, 2, 3, 4, 5, 6, 7}. In some embodiments, an indicator or a field for one first amplitude coefficient with value 0 may correspond to the first amplitude coefficient with value 0. In some embodiments, an indicator or a field for one first amplitude coefficient with value 1 may correspond to the first amplitude coefficient with value

$$\frac{1}{\sqrt{64}} .$$

In some embodiments, an indicator or a field for one first amplitude coefficient with value 2 may correspond to the first amplitude coefficient with value

$$\frac{1}{\sqrt{32}} .$$

In some embodiments, an indicator or a field for one first amplitude coefficient with value 3 may correspond to the first amplitude coefficient with value ¼. In some embodiments, an indicator or a field for one first amplitude coefficient with value 4 may correspond to the first amplitude coefficient with value

$$\frac{1}{\sqrt{8}} .$$

In some embodiments, an indicator or a field for one first amplitude coefficient with value 5 may correspond to the first amplitude coefficient with value ½. In some embodiments, an indicator or a field for one first amplitude coefficient with value 6 may correspond to the first amplitude coefficient with value

$$\frac{1}{\sqrt{2}} .$$

In some embodiments, an indicator or a field for one first amplitude coefficient with value 7 may correspond to the first amplitude coefficient with value 1.

In some embodiments, the value of the first amplitude coefficient corresponding to the first antenna port group (for example, the antenna port group with index Tₘ) may be 1. In some embodiments, the value of the indicator or the field for the first amplitude coefficient corresponding to the first antenna port group (for example, the antenna port group with index Tₘ) may be 15. In some embodiments, the value of the first amplitude coefficient or the indicator or the field for the first amplitude coefficient corresponding to the first antenna port group (for example, the antenna port group with index Tₘ) may not be reported in the PMI.

In some embodiments, the value of the first amplitude coefficient corresponding to the antenna port group which is not included in the second plurality of antenna port groups may be 0. In some embodiments, the value of the indicator or the field for the first amplitude coefficient corresponding to the antenna port group which is not included in the second plurality of antenna port groups may be 0. In some embodiments, the value of the first amplitude coefficient or the indicator or the field for the first amplitude coefficient corresponding to the antenna port group which is not included in the second plurality of antenna port groups may not be reported in the PMI.

In some embodiments, a value of one second amplitude coefficient may be at least one of

$$\{ \frac{1}{\sqrt{128}} , {( \frac{1}{8192} )}^{1 / 4} , \frac{1}{8} , {( \frac{1}{2048} )}^{1 / 4} , \frac{1}{2 \sqrt{8}} , {( \frac{1}{512} )}^{1 / 4} , \\ \frac{1}{4} , {( \frac{1}{128} )}^{1 / 4} , \frac{1}{\sqrt{8}} , {( \frac{1}{32} )}^{1 / 4} , \frac{1}{2} , {( \frac{1}{8} )}^{1 / 4} , \frac{1}{\sqrt{2}} , {( \frac{1}{2} )}^{1 / 4} , 1 \} .$$

In some embodiments, the bit size for one second amplitude coefficient may be 4 bits. In some embodiments, a value of an indicator or a field for one second amplitude coefficient may be at least one of {1, 2, 3, 4, 5, 6, 7, 8, 9, 10, 11, 12, 13, 14, 15}. In some embodiments, an indicator or a field for one second amplitude coefficient with value 0 may correspond to the second amplitude coefficient with value 0. In some embodiments, an indicator or a field for one second amplitude coefficient with value 1 may correspond to the second amplitude coefficient with value

$$\frac{1}{\sqrt{128}} .$$

In some embodiments, an indicator or a field for one second amplitude coefficient with value 2 may correspond to the second amplitude coefficient with value

$${( \frac{1}{8192} )}^{1 / 4} .$$

In some embodiments, an indicator or a field for one second amplitude coefficient with value 3 may correspond to the second amplitude coefficient with value 1 In some embodiments, an indicator or a field for one second amplitude coefficient with value 4 may correspond to the second amplitude coefficient with value

$${( \frac{1}{2048} )}^{1 / 4} .$$

In some embodiments, an indicator or a field for one second amplitude coefficient with value 5 may correspond to the second amplitude coefficient with value

$$\frac{1}{2 \sqrt{8}} .$$

In some embodiments, an indicator or a field for one second amplitude coefficient with value 6 may correspond to the second amplitude coefficient with value

$${( \frac{1}{512} )}^{1 / 4} .$$

In some embodiments, an indicator or a field for one second amplitude coefficient with value 7 may correspond to the second amplitude coefficient with value ¼. In some embodiments, an indicator or a field for one second amplitude coefficient with value 8 may correspond to the second amplitude coefficient with value

$${( \frac{1}{128} )}^{1 / 4} .$$

In some embodiments, an indicator or a field for one second amplitude coefficient with value 9 may correspond to the second coefficient with value

$$\frac{1}{\sqrt{8}} .$$

In some embodiments, an indicator or a field for one second second amplitude coefficient with value 10 may correspond to the second amplitude coefficient with value

$${( \frac{1}{32} )}^{1 / 4} .$$

In some embodiments, an indicator or a field for one second amplitude coefficient with value 11 may correspond to the second amplitude coefficient with value ½. In some embodiments, an indicator or a field for one second amplitude coefficient with value 12 may correspond to the second amplitude coefficient with value

$${( \frac{1}{8} )}^{1 / 4} .$$

In some embodiments, an indicator or a field for one second amplitude coefficient with value 13 may correspond to the second amplitude coefficient with value

$$\frac{1}{\sqrt{2}} .$$

In some embodiments, an indicator or a field for one second amplitude coefficient with value 14 may correspond to the second amplitude coefficient with value

$${( \frac{1}{2} )}^{1 / 4} .$$

In some embodiments, an indicator or a field for one second amplitude coefficient with value 15 may correspond to the second amplitude coefficient with value 1.

In some embodiments, a value of one second amplitude coefficient may be at least one of

$$\{ 0 , \frac{1}{\sqrt{64}} , \frac{1}{\sqrt{32}} , \frac{1}{4} , \frac{1}{\sqrt{8}} , \frac{1}{2} , \frac{1}{\sqrt{2}} , 1 \} .$$

In some embodiments, the bit size for one second amplitude coefficient may be 4 bits. In some embodiments, a value of an indicator or a field for one second amplitude coefficient may be at least one of {0, 1, 2, 3, 4, 5, 6, 7}. In some embodiments, an indicator or a field for one second amplitude coefficient with value 0 may correspond to the second amplitude coefficient with value 0. In some embodiments, an indicator or a field for one second amplitude coefficient with value 1 may correspond to the second amplitude coefficient with value

$$\frac{1}{\sqrt{64}} .$$

In some embodiments, an indicator or a field for one second amplitude coefficient with value 2 may correspond to the second amplitude coefficient with value

$$\frac{1}{\sqrt{32}} .$$

In some embodiments, an indicator or a field for one second amplitude coefficient with value 3 may correspond to the second amplitude coefficient with value ¼. In some embodiments, an indicator or a field for one second amplitude coefficient 4 with value 4 may correspond to the second amplitude coefficient with value

$$\frac{1}{\sqrt{8}} .$$

In some embodiments, an indicator or a field for one second amplitude coefficient with value 5 may correspond to the second amplitude coefficient with value ½. In some embodiments, an indicator or a field for one second amplitude coefficient with value 6 may correspond to the second amplitude coefficient with value

$$\frac{1}{\sqrt{2}} .$$

In some embodiments, an indicator or a field for one second amplitude coefficient with value 7 may correspond to the second amplitude coefficient with value 1.

In some embodiments, a value of one second amplitude coefficient may be at least one of

$$\{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} .$$

In some embodiments, the bit size for one second one of amplitude coefficient may be 3 bits. In some embodiments, a value of an indicator or a field for one second amplitude coefficient may be at least one of {0, 1, 2, 3, 4, 5, 6, 7}. In some embodiments, an indicator or a field for one second amplitude coefficient with value 0 may correspond to the second amplitude coefficient with value

$$\frac{1}{8 \sqrt{2}} .$$

In some embodiments, an indicator or a field for one second amplitude coefficient with value 1 may correspond to the second amplitude coefficient with value ⅛. In some embodiments, an indicator or a field for one second amplitude coefficient with value 2 may correspond to the second amplitude coefficient with value

$$\frac{1}{4 \sqrt{2}} .$$

In some embodiments, an indicator or a field for one second amplitude coefficient with value 3 may correspond to the second amplitude coefficient with value ¼. In some embodiments, an indicator or a field for one second amplitude coefficient with value 4 may correspond to the second amplitude coefficient with value

$$\frac{1}{2 \sqrt{2}} .$$

In some embodiments, an indicator or a field for one second amplitude coefficient with value 5 may correspond to the second amplitude coefficient with value ½. In some embodiments, an indicator or a field for one second amplitude coefficient with value 6 may correspond to the second amplitude coefficient with value

$$\frac{1}{\sqrt{2}} .$$

In some embodiments, an indicator or a field for one second amplitude coefficient with value 7 may correspond to the second amplitude coefficient with value 1. In some embodiments, one second amplitude coefficient may be a differential value corresponding to one first amplitude coefficient.

In some embodiments, a value of one second amplitude coefficient may be at least one of

$$\{ \frac{1}{\sqrt{2}} , 1 \} .$$

In some embodiments, the bit size for one second amplitude coefficient may one of be 1 bit. In some embodiments, a value of an indicator or a field for one second amplitude coefficient may be at least one of {0, 1}. In some embodiments, an indicator or a field for one second amplitude coefficient with value 0 may correspond to the second amplitude coefficient with value

$$\frac{1}{\sqrt{2}} .$$

In some embodiments, an indicator or a field for one second amplitude coefficient with value 1 may correspond to the second amplitude coefficient with value 1. In some embodiments, one second amplitude coefficient may be a differential value corresponding to one first amplitude coefficient.

In some embodiments, the value of the second amplitude coefficient corresponding to the antenna port group which is not included in the second plurality of antenna port groups may be 0. In some embodiments, the value of the indicator or the field for the second amplitude coefficient corresponding to the antenna port group which is not included in the second plurality of antenna port groups may be 0. In some embodiments, the value of the second amplitude coefficient or the indicator or the field for the second amplitude coefficient corresponding to the antenna port group which is not included in the second plurality of antenna port groups may not be reported in the PMI.

In some embodiments, a value of one third amplitude coefficient may be at least one of

$$\{ \frac{1}{8 \sqrt{2}} , \frac{1}{8} , \frac{1}{4 \sqrt{2}} , \frac{1}{4} , \frac{1}{2 \sqrt{2}} , \frac{1}{2} , \frac{1}{\sqrt{2}} , 1 \} .$$

In some embodiments, the bit size for one third amplitude coefficient may be 3 bits. In some embodiments, a value of an indicator or a field for one third amplitude coefficient may be at least one of {0, 1, 2, 3, 4, 5, 6, 7}. In some embodiments, an indicator or a field for one third amplitude coefficient with value 0 may correspond to the third amplitude coefficient with value

$$\frac{1}{8 \sqrt{2}} .$$

In some embodiments, an indicator or a field for one third amplitude coefficient with value 1 may correspond to the third amplitude coefficient with value ⅛. In some embodiments, an indicator or a field for one third amplitude coefficient with value 2 may correspond to the third amplitude coefficient with value

$$\frac{1}{4 \sqrt{2}} .$$

In some embodiments, an indicator or a field for one third amplitude coefficient with value 3 may correspond to the third amplitude coefficient with value ¼. In some embodiments, an indicator or a field for one third amplitude coefficient with value 4 may correspond to the third amplitude coefficient with value

$$\frac{1}{2 \sqrt{2}} .$$

In some embodiments, an indicator or a field for one third amplitude coefficient with value 5 may correspond to the third amplitude coefficient with value ½. In some embodiments, an indicator or a field for one third amplitude coefficient with value 6 may correspond to the third amplitude coefficient with value

$$\frac{1}{\sqrt{2}} .$$

In some embodiments, an indicator or a field for one third amplitude coefficient with value 7 may correspond to the third amplitude coefficient with value 1. In some embodiments, one third amplitude coefficient may be a differential value corresponding to one first amplitude coefficient and/or one second amplitude coefficient.

In some embodiments, a value of one third amplitude coefficient may be at least one of

$$\{ \frac{1}{\sqrt{2}} , 1 \} .$$

In some embodiments, the bit size for one third amplitude coefficient may be 1 bit. In some embodiments, a value of an indicator or a field for one third amplitude coefficient may be at least one of {0, 1}. In some embodiments, an indicator or a field for one third amplitude coefficient with value 0 may correspond to the third amplitude coefficient with value

$$\frac{1}{\sqrt{2}} .$$

In some embodiments, an indicator or a field for one third amplitude coefficient with value 1 may correspond to the third amplitude coefficient with value 1.

In some embodiments, for bits or codepoints or values of the one or more indicators (or one or more bitmaps) for indicating nonzero coefficients with value to be 0, the value of the first amplitude coefficient corresponding to the bits or codepoints or values may be set to be 0 and/or the value of an indicator or a field for the first amplitude coefficient corresponding to the bits or codepoints or values may be set to be 0. In some embodiments, the value of the first amplitude coefficient corresponding to the bits or codepoints or values and/or the value of an indicator or a field for the first amplitude coefficient corresponding to the bits or codepoints or values may not be reported in the PMI.

In some embodiments, for bits or codepoints or values of the one or more indicators (or one or more bitmaps) for indicating nonzero coefficients with value to be 0, the value of the second amplitude coefficient corresponding to the bits or codepoints or values may be set to be 0 and/or the value of an indicator or a field for the second amplitude coefficient corresponding to the bits or codepoints or values may be set to be 0. In some embodiments, the value of the second amplitude coefficient corresponding to the bits or codepoints or values and/or the value of an indicator or a field for the second amplitude coefficient corresponding to the bits or codepoints or values may not be reported in the PMI.

In some embodiments, for bits or codepoints or values of the one or more indicators (or one or more bitmaps) for indicating nonzero coefficients with value to be 0, the value of the third amplitude coefficient corresponding to the bits or codepoints or values may be set to be 0 and/or the value of an indicator or a field for the third amplitude coefficient corresponding to the bits or codepoints or values may be set to be 0. In some embodiments, the value of the third amplitude coefficient corresponding to the bits or codepoints or values and/or the value of an indicator or a field for the third amplitude coefficient corresponding to the bits or codepoints or values may not be reported in the PMI.

In some embodiments, for bits or codepoints or values of the one or more indicators (or one or more bitmaps) for indicating nonzero coefficients with value to be 0, the value of at least one of the first phase coefficient, the second phase coefficient and the third phase coefficient corresponding to the bits or codepoints or values may be set to be 0 and/or the value of an indicator or a field for at least one of the first phase coefficient, the second phase coefficient and the third phase coefficient corresponding to the bits or codepoints or values may be set to be 0. In some embodiments, the value of at least one of the first phase coefficient, the second phase coefficient and the third phase coefficient corresponding to the bits or codepoints or values and/or the value of an indicator or a field for at least one of the first phase coefficient, the second phase coefficient and the third phase coefficient corresponding to the bits or codepoints or values may not be reported in the PMI.

In some embodiments, a value of one first phase coefficient may be e^{j2π·c}^{ₚ}^{/N}^{_{PSK}}. In some embodiments, cₚ may be a value of one indicator or one field for the first phase coefficient. In some embodiments, a value of one second phase coefficient may be e^{j2π·c}^{ₚ}^{/N}^{_{PSK}}. In some embodiments, cₚ may be a value of one indicator or one field for the second phase coefficient. In some embodiments, a value of one third phase coefficient may be e^{j2π·c}^{ₚ}^{/N}^{_{PSK}}. In some embodiments, cₚ may be a value of one indicator or one field for the third phase coefficient. In some embodiments, cₚ may be a non-negative integer. In some embodiments, cₚ may be at least one of {0,1,2,3} or {0,1,2,3,4,5,6,7} or {0,1,2,3,4,5,6,7,8,9,10,11,12,13,14,15}. In some embodiments, N_{PSK} may be the size for indication of cₚ. In some embodiments, N_{PSK} may be a positive integer. In some embodiments, N_{PSK} may be at least one of {2, 4, 8, 16}.

In some embodiments, the number of one or more indicators (or the field) for the plurality of first amplitude coefficients may be K_{b1}*(T−1) or K_{b1}*(T₁−1) or K_{b1}*(Tₛ−1) or K_{b1}*Σ_{t=0, and t≠T}_{ₘ}^{T-1}N_{g,t}. In some embodiments, K_{b1} may be the bit size for each of the first amplitude coefficients. For example, K_{b1} may be 2 or 3 or 4 bits.

In some embodiments, the number of one or more indicators (or the field) for the plurality of first amplitude coefficients may be based on the number of the plurality of fourth vectors and either one of: the number of the first plurality of antenna port groups; or the number of the second plurality of antenna port groups.

In some embodiments, the number of one or more indicators (or the field) for the plurality of first amplitude coefficients may be K_{b1}*(T−1)*M_{w} or K_{b1}*(T₁−1)*M_{w} or K_{b1}*(Tₛ−1)*M_{w} or K_{b1}*M_{w}*Σ_{t=0, and t≠T}_{ₘ}^{T-1}N_{g,t}.

In some embodiments, the one or more indicators (or the field) for the plurality of first amplitude coefficients may be comprised in the PMI or in the first part of the PMI or in the second part of the PMI.

In some embodiments, the number of one or more indicators (or the field) for the plurality of first phase coefficients may be based on the number of the first plurality of antenna port groups or the number of the second plurality of antenna port groups. In some embodiments, the number of one or more indicators (or the field) for the plurality of first phase coefficients may be based on the number of the first plurality of antenna port groups minus 1 or the number of the second plurality of antenna port groups minus 1.

In some embodiments, the number of one or more indicators (or the field) for the plurality of first phase coefficients may be K_{b2}*(T−1) or K_{b2}*(T₁−1) or K_{b2}*(Tₛ−1) or K_{b2}*Σ_{t=0, and t≠T}_{ₘ}^{T-1}N_{g,t}. In some embodiments, K_{b2} may be the bit size for each of the first phase coefficients. For example, K_{b2} may be 2 (e.g. N_{PSK}=4) or 3 (e.g. N_{PSK}=8) or 4 bits (e.g. N_{PSK}=16).

In some embodiments, the number of one or more indicators (or the field) for the plurality of first phase coefficients may be based on the number of the plurality of fourth vectors and either one of: the number of the first plurality of antenna port groups; or the number of the second plurality of antenna port groups.

In some embodiments, the number of one or more indicators (or the field) for the plurality of first phase coefficients may be K_{b2}*(T−1)*M_{w} or K_{b2}*(T₁−1)*M_{w} or K_{b2}*(Tₛ−1)*M_{w} or K_{b2}*M_{w}*Σ_{t=0, and t≠T}_{ₘ}^{T-1}N_{g,t}.

In some embodiments, a first vector may be after a schimidt orthogonalization based on the first vectors in this disclosure.

In some embodiments, antenna ports of the first plurality of antenna port groups may be in one CSI-RS resource. In some embodiments, each antenna port group may be at least one of: antenna ports within one code domain multiplexing (CDM) group in the CSI-RS resource; and a subset of antenna ports for the CSI-RS resource. In some embodiments, each antenna port group in the first and/or second plurality of antenna port groups may correspond to one CSI-RS resource. In some embodiments, different antenna port groups in the first and/or second plurality of antenna port groups may correspond to different CSI-RS resources.

In some embodiments, the terminal device may determine and/or report a first set of codebook indicators and a second set of codebook indicators in one CSI report or in one PMI report. In some embodiments, the first set of codebook indicators may correspond to a first value of the number of the second plurality of antenna port groups, and the second set of codebook indicators may correspond to a second value of number of the second plurality of antenna port groups. In some embodiments, at least one parameter or indicator corresponding to the first set of codebook indicators may be different from at least one parameter or indicator corresponding to the second set of codebook indicators. In some embodiments, the value of N3 corresponding to the first set of codebook indicators may be no larger than or less than the value of N3 corresponding to the second set of codebook indicators. In some embodiments, a value of the first parameter and/or a value of the fourth parameter corresponding to the first set of codebook indicators may be no larger than or less than a value of the first parameter and/or a value of the fourth parameter corresponding to the second set of codebook indicators. In some embodiments, the first value of the number of the second plurality of antenna port groups may be 1. In some embodiments, the second value of the number of the second plurality of antenna port groups may be 2 or 3 or 4. In some embodiments, the first set of codebook indicators may be single-TRP hypothesis. In some embodiments, the second set of codebook indicators may be multi-TRP hypothesis.

In some embodiments, the bit size of the one or more indicators or fields for the plurality of third amplitude coefficients and/or the bit size of the one or more indicators or fields for the plurality of third phase coefficients corresponding to the first set of codebook indicators may be less than the bit size of the one or more indicators or fields for the plurality of third amplitude coefficients and/or the bit size of the one or more indicators or fields for the plurality of third phase coefficients corresponding to the second set of codebook indicators.

In some embodiments, the bit size of the one or more indicators for the plurality of first vectors and/or the bit size of the one or more indicators for the plurality of second vectors may be based on ceil(log 2(nchoosek(N₁N₂, L))) or ceil(log 2(nchoosek(N₁N₂, Lₜ*T))) or ceil(log 2(nchoosek(N₁N₂, Lₜ*T₁))) or ceil(log 2(nchoosek(N₁N₂, Lₜ*Tₛ))).

In some embodiments, an indicator or a field for the plurality of first vectors may indicate a group of first vectors or a group of second vectors. For example, the number of first vectors or the number of second vectors in the group may be Lₜ or L or Lₜ*T₁ or Lₜ*Tₛ. In some embodiments, an indicator or a field for the plurality of second vectors may indicate a group of second vectors. For example, the number of second vectors in the group may be Lₜ or L or Lₜ*T₁ or Lₜ*Tₛ.

In some embodiments, the terminal device 130 may be configured or indicated with a number of layers (e.g. represented as v_ri) for the PUSCH transmission. For example, the number of layers v_ri may be at least one of {1,2,3,4,5,6,7,8}. In some embodiments, the terminal device 130 may be configured or indicated with a precoding matrix for the PUSCH transmission. In some embodiments, the size of the precoding matrix may be 8*v_ri or v_ri*8. In some embodiments, there may be v_ri columns or rows in the precoding matrix. In some embodiments, in a column or row of the precoding matrix, there may be 8 elements, and index of an element may be represented as idx, idx may be non-negative integer. For example, 0<=idx<=7. For another example, 1<=idx<=8.

In some embodiments, the terminal device may be configured with an uplink transmission type to be OFDM. In some embodiments, in case of OFDM, a set of uplink codebook may include a codebook with all ones in the precoding matrix or precoding vector. In some embodiments, the terminal device may be configured with an 8 transmission (8 Tx) or 8-port SRS for uplink transmission. In some embodiments, for one layer precoding matrix, in case of OFDM, a precoder

$${\frac{1}{\sqrt{8}} [ \begin{matrix}1 & 1 & 1 & 1 & 1 & 1 & 1 & 1\end{matrix} ]}^{T}$$

may be included in the set of uplink codebook. In some embodiments, the terminal device may be configured with an uplink transmission type to be DFT-s-OFDM or single carrier frequency domain multiplexing access (ScFDMA). In some embodiments, in case of DFT-s-OFDM or ScFDMA, a set of uplink codebook may not include a codebook with all ones in the precoding matrix or precoding vector. In some embodiments, for one layer precoding matrix, in case of DFT-s-OFDM or ScFDMA, a precoder

$${\frac{1}{\sqrt{8}} [ \begin{matrix}1 & 1 & 1 & 1 & 1 & 1 & 1 & 1\end{matrix} ]}^{T}$$

may not be included in the set of uplink codebook.

In some embodiments, a terminal device comprise circuitry configured to perform: receiving, from a network device, at least one configuration for codebook.

In some embodiments, the terminal device comprise circuitry configured to perform: determining the at least one codebook indicator based on the at least one configuration for codebook.

In some embodiments, the terminal device comprise circuitry configured to perform: transmitting, to the network device, the at least one codebook indicator.

In some embodiments, the terminal device comprise circuitry configured to perform: receiving, from the network device, at least one CSI-RS based on the at least one configuration.

In some embodiments, the network device comprises circuitry configured to perform: transmitting, to the terminal device, the at least one configuration for codebook.

In some embodiments, the network device comprises circuitry configured to perform: receiving, from the terminal device, the at least one codebook indicator.

In some embodiments, the network device comprises circuitry configured to perform: transmitting, to the terminal device, at least one CSI-RS based on the at least one configuration.

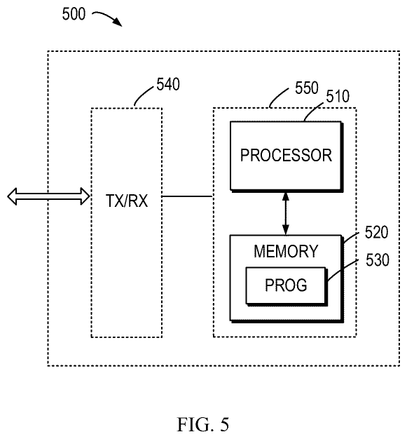

FIG. 5 is a simplified block diagram of a device 500 that is suitable for implementing embodiments of the present disclosure. The device 500 can be considered as a further example implementation of the terminal device or the network device as shown in FIG. 1. Accordingly, the device 500 can be implemented at or as at least a part of the terminal device or the network device.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 520 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the eNB and a relay node (RN), or Uu interface for communication between the eNB and a terminal device.

The program 530 is assumed to include program instructions that, when executed by the associated processor 510, enable the device 500 to operate in accordance with the embodiments of the present disclosure, as discussed herein with reference to FIGS. 2 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

1-23. (canceled)

24. A method, performed by a terminal device, the method comprising:
receiving, from a network device, a configuration comprising a plurality of reference signal resources; and
transmitting, to the network device, information comprising a first indicator of one or more reference signal resources selected from the plurality of reference signal resources and a second indicator of a plurality of first vectors,
wherein:
a plurality of second vectors are determined based on the plurality of first vectors,
a length of a second vector among the plurality of second vectors is determined based on a number of the one or more reference signal resources, and
a bit size of the second indicator is determined based on the number of the one or more reference signal resources.

25. The method of claim 24, wherein:
the information further comprises a third indicator for a plurality of first phase coefficients, and
the plurality of second vectors are determined based on the plurality of first vectors and the plurality of first phase coefficients.

26. The method of claim 24, wherein:
the information further comprises a fourth indicator for a plurality of amplitude coefficients, a fifth indicator for a plurality of second phase coefficients and a bitmap,
the bitmap indicating which amplitude coefficient in the fourth indicator is reported and which phase coefficient in the fifth indicator is reported, and
a bit size of the bitmap is determined based on the number of the one or more reference signal resources.

27. The method of claim 24, wherein:
the information further comprises a sixth indicator for a strongest coefficient corresponding to one layer, and
a bit size of the sixth indicator is determined based on the number of the one or more reference signal resources.

28. A method, performed by a network device, the method comprising:
transmitting, to a terminal device, a configuration comprising a plurality of reference signal resources; and
receiving, from the terminal device, information comprising a first indicator of one or more reference signal resources selected from the plurality of reference signal resources and a second indicator of a plurality of first vectors,
wherein:
a plurality of second vectors are determined based on the plurality of first vectors,
a length of a second vector among the plurality of second vectors is determined based on a number of the one or more reference signal resources, and
a bit size of the second indicator is determined based on the number of the one or more reference signal resources.

29. The method of claim 28, wherein:
the information further comprises a third indicator for a plurality of first phase coefficients, and
the plurality of second vectors are determined based on the plurality of first vectors and the plurality of first phase coefficients.

30. The method of claim 28, wherein:
the information further comprises a fourth indicator for a plurality of amplitude coefficients, a fifth indicator for a plurality of second phase coefficients and a bitmap,
the bitmap indicating which amplitude coefficient in the fourth indicator is reported and which phase coefficient in the fifth indicator is reported, and
a bit size of the bitmap is determined based on the number of the one or more reference signal resources.

31. The method of claim 28, wherein:
the information further comprises a sixth indicator for a strongest coefficient corresponding to one layer, and
a bit size of the sixth indicator is determined based on the number of the one or more reference signal resources.

32. A terminal device, comprising a processor configured to cause the terminal device to:
receive, from a network device, a configuration comprising a plurality of reference signal resources; and
transmit, to the network device, information comprising a first indicator of one or more reference signal resources selected from the plurality of reference signal resources and a second indicator of a plurality of first vectors,
wherein:
a plurality of second vectors are determined based on the plurality of first vectors,
a length of a second vector among the plurality of second vectors is determined based on a number of the one or more reference signal resources, and
a bit size of the second indicator is determined based on the number of the one or more reference signal resources.

33. The terminal device of claim 32, wherein:
the information further comprises a third indicator for a plurality of first phase coefficients, and
the plurality of second vectors are determined based on the plurality of first vectors and the plurality of first phase coefficients.

34. The terminal device of claim 32, wherein:
the information further comprises a fourth indicator for a plurality of amplitude coefficients, a fifth indicator for a plurality of second phase coefficients and a bitmap,
the bitmap indicating which amplitude coefficient in the fourth indicator is reported and which phase coefficient in the fifth indicator is reported, and
a bit size of the bitmap is determined based on the number of the one or more reference signal resources.

35. The terminal device of claim 32, wherein:
the information further comprises a sixth indicator for a strongest coefficient corresponding to one layer, and
a bit size of the sixth indicator is determined based on the number of the one or more reference signal resources.
